(19) United States
(12) Patent Application Publication
(10) Pub. No.: US 2008/0098450 A1
(43) Pub. Date: Apr. 24, 2008

(54) Dual display apparatus and methodology for broadcast, cable television and IPTV

(75) Inventors: Ching Song (John C.S.) Wu, Taipei (TW); Youngwoan Cho, San Pedro, CA (US)

Correspondence Address: Steven Fischman, Scully, Scott,;Murphy & Presser, 400 Garden City Plaza, Garden City, NY, 11530, US

(73) Assignee: Toptrend Global Technologies, Inc., Las Vegas, NV (US)

(21) Appl. No.: 11/581,594

(22) Filed: Oct. 16, 2006

(51) Int. Cl. H04N 7/16; H04N 7/173; G06F 9/00; G06F 15/177

(52) U.S. Cl. 725/132; 725/140; 725/152; 713/2; 725/113; 725/118

(57) ABSTRACT

A set top box (“STB”) apparatus configurable for handling broadcast, cable television and Internet protocol television (“IPTV”) formats by multiple operators via a single flexible operating system is provided. The set top box is enabled to receive and run different operating systems from multiple providers or operators. In another aspect, a dual mode display feature enables viewing of digital content via a first display device while enabling browsing and e-commerce functionality via an associated remote device.

### FIELD OF THE INVENTION

The present disclosure relates to a set top box (“STB”) apparatus configurable for handling broadcast, cable television and Internet protocol television (“IPTV”) formats by multiple operators via a single flexible operating system. The invention further relates to a dual mode display feature that enables viewing of digital content via a first display device while enabling browsing and e-commerce functionality via an associated remote device.

### BACKGROUND OF THE INVENTION

Television content delivered to the viewers includes television programs and advertisements, which are broadcast over the traditional broadcasting medium such as cable and satellite. Other enhanced information may be added to the television content and delivered.

Internet Protocol Television (IPTV) refers to a system where television content is provided to viewers over the Internet, for instance, over a broadband network infrastructure. This type of service often is provided together with other Internet services such as web access, voice over IP (VoIP), video on demand (VOD). At the viewer's end, a computer such as a personal computer (PC) or a set top box connected to a television may receive the television content delivered as Internet protocol packets, reassemble and display the content on the television.

The world market is rapidly adopting the IPTV technology. Internet connections and network infrastructure continuously expanding throughout the globe in conjunction with high technology improvements in computing power are all contributing to this adoption. The Internet connectivity and digitized format offer advantages to the television content delivery, which was not thought possible with the traditional broadcasting mechanism. For instance, interactivity can be achieved between viewer and providers of service. Advertisements may be added or otherwise manipulated into the media content to cater to businesses. IPTV affords a wide range of business opportunities for providers of media and enterprises advertising their products and services. With such advent in IPTV technology, many players such as telephone companies and cable companies are vying for the share of the marketplace.

One of the challenges that limit consumers and add heavy costs to providers in IPTV, cable and digital broadcast services is the requirement that STB devices be configured according to the proprietary platform and communications protocols of the service operators and their carrier networks. That is, as STB devices are currently not off-the-shelf devices and typically provided as part of a bundled package through the cable network operator (service provider), e.g., when a user subscribes to cable TV service, they are generally equipped with proprietary carrier formats and only compatible for use with a specified network cable operator and perhaps, equipped with a proprietary or specialized operating system. As such, such STB's are typically low-end devices and are not transportable, i.e., they cannot be used to receive content from other cable network operators. Thus, a user who re-locates across the country will not be able to use his/her current STB with another cable network service provider and/or carrier network as it would not be configured for compatibility.

It would thus be desirable to provide a flexible operating system for a STB that is configurable to adapt to the operating preferences and protocols of different cable television broadcast carrier and IPTV networks, including the ability to download and implement proprietary formats of different carrier networks.

In view of the development of IPTV and the broad range of digital content that is now available, the amount of media content and data that can be transmitted in ITPV to viewers is limitless. In the existing IPTV technology, however, all the information of a program including one or more of: a video portion, a text portion, and an interactive portion, etc., that is delivered to a viewer, is adapted for presentation on a single display device such as the television. To a viewer, so much different information may look cluttered and confusing, thus discouraging interactivity with the STB that some cable television and IPTV programs may encourage, e.g., conducting e-commerce transactions such as web purchases. Accordingly, what is desirable is a system and method that can present video and text in an organized manner preferred by viewers.

What is also desirable is an integrated platform including a hardware and software infrastructure that enables digital/analog television for viewers in an organized manner preferably presenting video and text in separate devices convenient to users and facilitating (full duplex) interactivity between the user and the STB.

What is further desirable is an integrated platform including a hardware and software infrastructure that enables digital television for viewers and further enables users to seamlessly conduct e-commerce transactions via a first display device of a dual display apparatus by providing user management and payment functions with various providers of the IPTV services.

What is further desirable is a highly functional STB device that supports communications from broadcast, cable TV and IPTV operators alike, and, enables multiple interfaces, including USB, RS232, wireless to provide real interactivity (full duplex) with a highly functional panel remote device enabled to provide encrypted, secure (wireless) communication with the STB.

### BRIEF SUMMARY OF THE INVENTION

In one aspect, the present invention is directed to a flexible operating system for a STB that is configurable to adapt to the operating preferences and protocols of different cable television carrier networks, IPTV networks, electronic programming guide provider networks, and the like, including the ability to download and implement proprietary formats of different carrier networks.

A flexible operating system STB in one aspect may include an operating system operable to boot a set top box and prompt for and receive user selected media service operator. The operating system may be further operable to download a second operating system associated with the selected media service operator for providing media service to the user from the selected media service operator. A memory space is available for storing the second operating system associated with the selected media service operator. A runtime emulator interprets and converts the second operating system associated with the selected media service operator to common machine code operable to run on a hardware platform of a set top box.

A method in one aspect for using a common set top box to provide services from a plurality of media service operators may include prompting a user to select a service operator from a plurality of operators, receiving a public key associated with a selected operator, downloading a proprietary operating system associated with the selected operator using the public key, and converting the proprietary operating system to a machine code executable by the common set top box.

In another aspect of the invention, there is provided an STB configured for providing a dual display functionality capable of presenting digital cable/satellite broadcast and Internet Television (IPTV) and interactive content (such as advertisements or reality TV voting) on two separate devices: 1) a first device for receiving and playing a programmed presentation; and 2) a second device for providing control features for the STB and especially configured to provide browsing functionality, view interactive advertising and enable e-commerce transactions to be conducted via the second device, without interruption of the program being presented on the first display device. In one embodiment, the second device is a remote and portable device, such as a small form factor tablet or PDA. In this manner, the STB functions as a local server to the remote and portable device.

In one aspect, a dual display apparatus may include a flexible operating system set-top box (STB) configurable for receiving broadband media signals embodying a multimedia presentation from a content provider. The received signals further may include viewable supplemental information content relating to the multimedia presentation. The flexible operating system STB may be associated with a playback device adapted for playing said multimedia presentation. A parser may reside in the set top box, for parsing out the supplemental information content from the received broadband media signals. An associated remote device may be adapted to communicate with the STB for controlling STB operations. A first communication sub-system may enable wireless communication between the STB and the remote device, the remote device receiving the parsed out supplemental information content communicated from the STB, and the associated remote device having a display interface for viewing the received supplemental information content. In one aspect, by using the apparatus of the present disclosure, user may experience an increase in comfort level by viewing the supplemental information content via the associated remote device display and the multimedia presentation on the playback device.

A method for viewing content in one aspect may include configuring a flexible operating system of a set-top box (STB) to receive and process broadband media signals embodying a multimedia presentation from a content provider, the received signals further including viewable supplemental information content relating to the multimedia presentation, the flexible operating system STB associated with a playback device adapted for playing the multimedia presentation. The method may further include parsing out, via a parser residing in the set top box, the supplemental information content from the received broadband media signals, providing an associated remote device adapted to wirelessly communicate with the STB via a first communication sub-system, the remote device receiving the parsed out supplemental information content communicated from the STB, the associated remote device having a display interface for viewing the received supplemental information content. The method may also include enabling the supplemental information content to be viewed via the associated remote device display while the multimedia presentation is being viewed on said playback device, thereby increasing a user viewing experience comfort level.

In one embodiment, the two display devices (TV 50 and table/PDA) include display screens of different resolutions and enable different viewing distances that overcome the human's eyes discomfort and behavior issues while perceiving both media and data at same time.

In another aspect, a method of providing interactive shopping capabilities to a user while receiving media services from a media operator may include parsing data received from a media operator to separate the data into at least media program content and advertisement content, sending the media program content to a device for presenting media program to a user, sending the advertisement content to an interactive device, presenting the advertisement content on the interactive device, and allowing the user to select and purchase one or more products or services advertised in the advertisement content via the interactive device without interrupting the media program presented on the device for presenting media program to a user.

Advantageously, the STB of the invention that is equipped with such flexible O/S that is made available for off-the-shelf purchase for consumer use in various locations and adapted to operate under various cable network carrier and IPTV platforms and the like will encourage further widespread use and adoption of these formats, and will facilitate and encourage increased e-commerce transactions by users, thus, increasing revenue for the advertisers, cable and IPTV service providers and operators alike thereby fueling the internet economy. This is all the more bolstered by a dual mode display technology that facilitates conduction of e-commerce transactions via a first remote device without interrupting the main presentation or broadcast feature that is viewable via a first display device (e.g., a TV).

### BRIEF DESCRIPTION OF THE DRAWINGS

Further features as well as the structure and operation of various embodiments are described in detail below with reference to the accompanying drawings. In the drawings, like reference numbers indicate identical or functionally similar elements.

FIG. 1 illustrates the dual display infrastructure 10 for Cable+IPTV/Broadcast+IPTV/IPTV of the present disclosure according to one embodiment of the invention.

FIG. 2 illustrates a system operation model in one embodiment of the present disclosure.

FIG. 3 illustrates an example STB device schematic diagram according to one embodiment of the invention.

FIG. 4 is a diagram illustrating the software architecture for the STB device according to one embodiment of the invention.

FIG. 5 illustrates a panel remote device schematic diagram according to one embodiment of the invention.

FIG. 6 illustrates software architecture for the panel remote device in one embodiment of the invention.

FIG. 7 is a flow diagram illustrating a method of operating the flexible operating system set top box of the present disclosure in one embodiment.

FIG. 8 is a flow diagram illustrating a method of downloading media operator's operating system to STB of the present disclosure in one embodiment.

FIG. 9 is a block diagram illustrating downloading of operating systems from selected service providers in one embodiment.

FIG. 10 is a block diagram that illustrates contents of STB memory in one embodiment.

FIG. 11 shows an example of a web page screen shot that a STB user may see when he or she logs in to the system of the present disclosure.

FIG. 12 shows an example of a web page that may be presented to a user for selecting cable or satellite operator.

FIG. 13 is an example screen shot of a web page that may be presented to a user for selecting broadcast EPG operator.

FIG. 14 is an example screen shot of a web page that may be presented to a user for collecting user information for the service selected.

FIG. 15 is a diagram illustrating operation support system (OSS) architecture in one embodiment of the present disclosure.

FIG. 16 illustrates a schema for downloading a cable/broadcast OS data from an operator in one embodiment of the present disclosure.

FIG. 17A and FIG. 17B show an example of displays on a panel remote when the user selects broadcast mode.

FIG. 18 is a flow diagram illustrating interactive shopping that a user may perform using the STB of the present disclosure in one embodiment.

FIG. 19 is a diagram illustrating an instance in which a user is able to view a TV or cable program and also purchase a product shown on the program.

FIGS. 20A and 20B depict one embodiment of a metadata format utilized in connection with a digital media presentations received by the STB of the present invention.

FIG. 21A depicts how broadcast and cable operators will provide streaming content that the STB device of the invention can receive; and,

FIG. 21B depicts how IPTV operators will provide streaming content that the STB device of the invention can receive.

FIG. 22 depicts how the streamed digital content including the metadata content is processed by the STB of the invention and how users interact with the STB for conducting e-commerce transactions.

FIG. 23 depicts the detailed processing executed within the STB device of the invention.

FIG. 24 is a diagram illustrating a business revenue flow in one embodiment among a plurality of components in the present disclosure.

### DETAILED DESCRIPTION

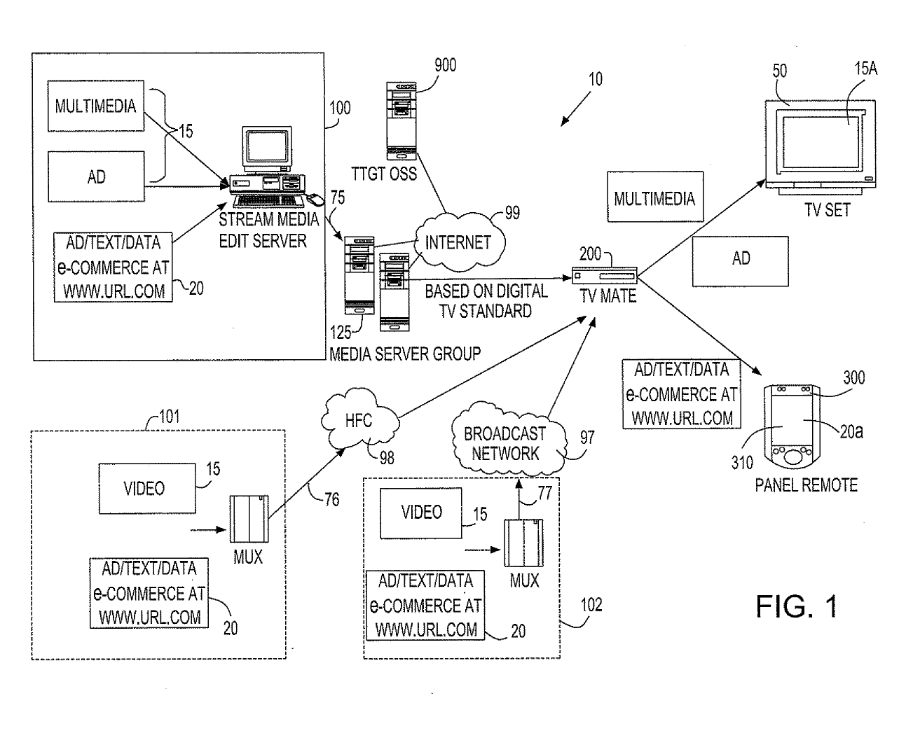

The dual display apparatus and methodology for presenting digital broadcast (e.g., cable) or Internet Television (IPTV) content on two separate devices is now shown with respect to FIG. 1. As shown in FIG. 1, the dual display infrastructure 10 for Cable+IPTV/Broadcast+IPTV/IPTV includes four technologies components: 1) an encoding/authoring/multiplexing technology component 100-102 that enables the storing, formatting, clustering and provisioning of multiple content including: video, audio or audio/video (A/V) content to be presented 15, and/or related or un-related graphic, data and/or textual content 20 that is assembled for delivery according to respective IPTV, Cable/IPTV and broadcast/IPTV formats according to the invention. For example, the multiplexed IPTV content may be provisioned as a single IP transport stream 75 for receipt by a user over the Internet 99. Likewise, multiplexed Cable/IPTV content may be provisioned as a cable broadcast transport stream 76 for receipt by a user over a hybrid fiber-coax (HFC) cable network 98, and similarly, the multiplexed Broadcast/IPTV content may be provisioned as a broadcast transport stream 77 for receipt by a user over a Broadcast network 97; 2) a distribution technology component 125 including, for example, a distribution server or like device that provides the clustered and formatted content to a user's device via the Internet 99 or cable network or broadcast network; 3) an intelligent Set-Top Box (STB) component 200 as either a stand-alone unit or integrated within a television set that includes a Parsing Engine, a packet redistribution means when P2P enabled, and additional Digital Rights Management (DRM) control functions that provides the dual display mode platform with enhancements for P2P functionality, dynamic DRM, etc.; and, 4) the dual display mode infrastructure including a television monitor or like TV display device 50 adapted for presenting multimedia presentations 15a, and, a remote device such as a tablet or like PDA-type device 300 having a display 310 adapted for viewing program related or un-related graphic, data and/or textual content 20a such as advertisements and hyperlinks. As will be described in greater detail herein, the remote device such as a tablet or like PDA-type device 300 (also referred interchangeably as a panel remote device) enables a user to surf the web and/or conduct e-commerce transactions via a broadband connection to the Internet, while a broadcast A/V presentation 15a is being viewed on that user's TV display device 50. Additionally depicted in FIG. 1 is the provision of an Operation Support System (OSS) 900 for providing, in an exemplary embodiment, support for value-added operation for the Cable+IPTV/Broadcast+IPTV and IPTV platforms. The operation support system (OSS) 900 particularly is enabled to connect to Internet web sites, servers of telephone companies and/or cable companies for handling various controls, managements, and/or interface functions for services, customers, and/or back-end systems as will be described in greater detail hereinbelow.

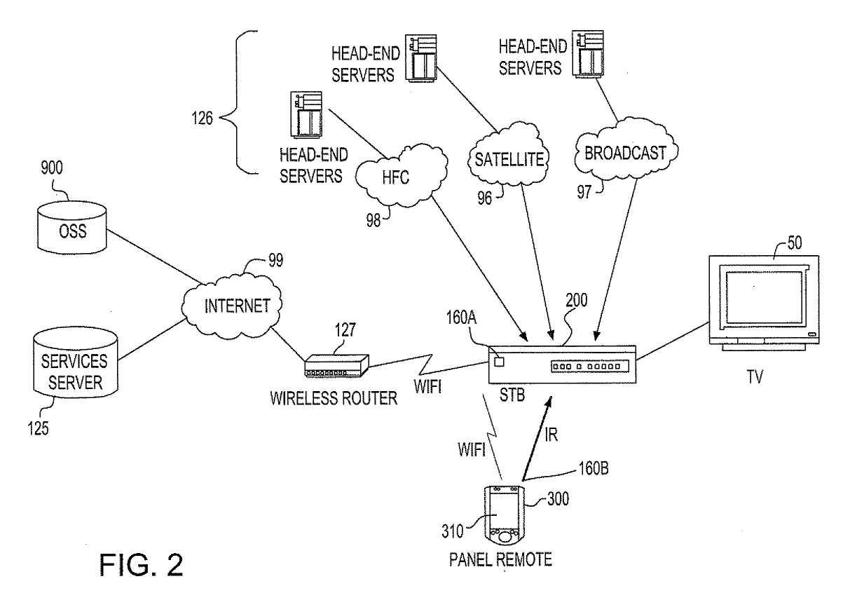

With reference to FIG. 2, there is depicted a display device including the intelligent Set-Top Box (STB) component 200. As will be described in greater detail herein, the intelligent Set-Top Box component 200 functions as a client device to the distribution technology component (e.g., services servers) 125 for content access. More particularly, as will be described in greater detail herein, media content are provided by one or more media sources (content providers or producers). Embodied as examples of media sources include head-end server devices 126 providing content, respectively, from broadcast stations via broadcast network 97, from a satellite receiver over a satellite communications network 96, and, from a cable network operator via a cable (HFC) network 98. Media content is additionally provided from television relay stations and Internet sites that provide continuous media data over the Internet 99. A media delivery system comprises one or more servers 125, typically operated by, a service provider, IP media provider, broadcaster or a media deliver center. The STB component 200 further functions as a local server to the remote device such as a tablet or like PDA-type device 300 as it transmits both a navigable web page and/or applications and/or graphics/data/textual content.

That is, according to the invention, the STB provides a software architecture that enables TCP/IP packets comprising an IPTV broadcast or presentation to be parsed such that the regular A/V television content is processed for display on the user's TV monitor or like display device, and other content such as related graphics/data/text is processed for transmission to and display on the user's remote device (tablet) simultaneous with the presentation of the transmitted A/V content on the TV monitor or like display device. In this regard, both the STB component 200 and remote device such as a tablet or like PDA-type device 300 is provided with wireless communications capability, e.g., Bluetooth or Wi-Fi (IEEE 802.11 specification) technology, and IrDA (Infrared) and like short range wireless transceivers 160a, 160b. It is understood that a wireless or wired solution may also be implemented for enabling communication between the STB component 200 and a router 127. Thus, in one manner, the STB component 200 may communicate with the Internet via a wireless modem and/or router 127 for receiving content from the servicing servers 125 to be parsed and displayed on the main screen display device 50 and, including content to be bundled for communication to the remote device 300 for display thereat. In one embodiment, the two display devices (e.g., TV 50 and tablet/PDA 300) include display screens of different resolutions and enable different viewing distances that overcome the human's eyes discomfort and behavior issues while perceiving both media and data at same time. In one embodiment, the STB system 200 ensures that control buttons are generated for display on the Panel Remote 300 for the interactive browsing, however, as will be explained, the system is configurable. The resolution of a display (e.g., TV device) may be one or more of the following: 640×480P, 1080×720P, 1280×1080i, 1280×1080p or higher resolution. The resolution of the Remote device's resolution is VGA or less resolution (e.g., 640×480) so the Parsing engine in the intelligent STB 200 formats the original webpage to fit the VGA or less resolution for the Remote device display. OSS 900 provides backend and server functionalities to the STB system 200 such as initialization and downloading of various operators' operating systems to STBs, authentication and security functionalities, e-commerce functionalities, and other value-added operations to the media service platform.

### STB Hardware Architecture

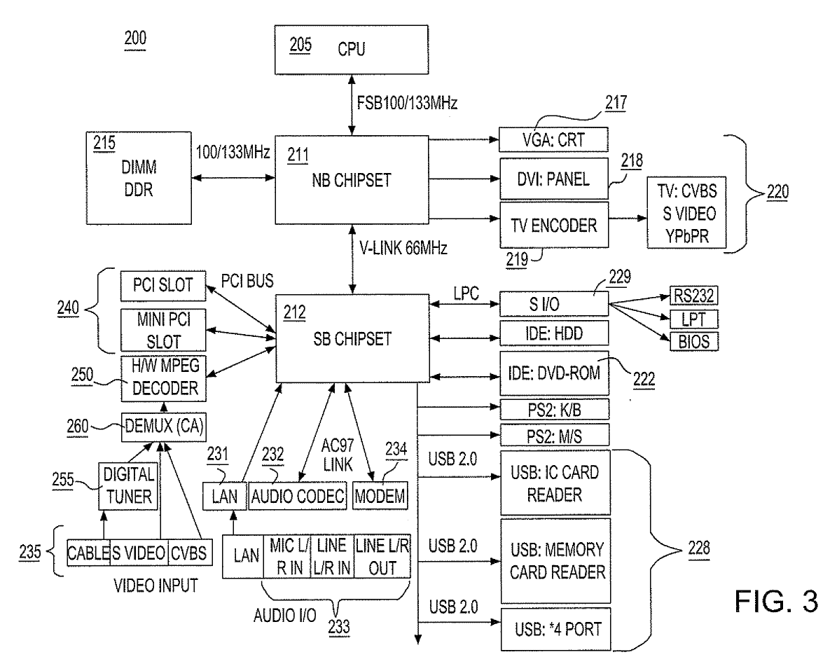

The intelligent Set-Top Box (STB) 200, in one embodiment, is configured as shown in FIG. 3 adapted for receiving content from a media delivery system. As shown in FIG. 3, there are included specialized hardware components for receiving and processing cable, broadcast television media content including MPEG-2, -4 or other compressed multimedia formats (e.g., MPEG-1, JPEG) that provide the digital content for STBs and digital televisions. However, the STB 200 of the present invention differs from conventional STB boxes currently available in that it is highly functional as it supports cable, broadcast and IP network operator modes and is available “off the shelf” in contrast to conventional STBs that are only available through one service provider. Furthermore, the STB 200 enables real (full duplex) interactivity, it can execute multiple types of applications such as on-line gaming, and, is further is equipped to communicate with the high functioning panel remote device 300 in an encrypted, secure wireless communication with the STB.

As shown in FIG. 3, while general-purpose microprocessors may be used, such as the PowerPC 401 and the like that are typically used in STBs and digital televisions for controlling MPEG components as well as for executing applications such as a program guide used by the viewer, a more robust processor such as the C3/Eden processor 205 (available from VIA Technologies, Inc.) operable at over 1 GHz at extremely low power, is preferable as it delivers exceptional performance for Internet, and multimedia applications, including MPEG2, MPEG4 and other formats, video playback, MP3 audio playback, Voice over IP and video conferencing applications, multimedia slideshows and web browsing. Operable in conjunction with the processor 205 is a video processing chipset 211, 212 (such as the CLE266 also available from VIA Technologies, Inc.) comprising a processing core that provides a sturdy 2D/3D graphics engine and ultra efficient DDR memory controller 215 supporting data rates at 100/133 MHz DDR to enable high quality digital video streaming. It is understood that more robust processors may be incorporated in the STB of the invention, including those chipsets provided by Intel, AMD, or other x86-based framework hardware.

Particularly, as shown in FIG. 3, the CLE266 chipset includes a “North-bridge” chip 211 interfacing with the CPU, DDR memory subsystem and providing the dual monitor outputs (including television signal) outputs 220. The north-bridge chip thus incorporates a memory controller; CPU interface; integrated graphics and video accelerator inside; extensive display support including a 2D/3D hardware acceleration. Thus, the video processing chipset is enabled to provide the A/V television signal outputs 220 and additionally provides both a VGA graphics interface 217 to a CRT display (monitor), and a Digital Video Interface 218 for digital TV sets that is built into the STB to provide the video connection to the STB. Further, a TV encoder device 219 is provided that receives television (TV) signals that are in an analog format and digitizes the TV signals and converts the digitized TV signals to a digital format so that the signals can be further processed for display at the TV.

The CLE266 chipset further includes a “South-bridge” chip 212 including a PCI controller, a LPC (low pin count) peripheral controller, a keyboard and PS/2 mouse controller, an IDE device controller, etc. Associated functionality includes receiving network (LAN), cable, audio and video signal inputs and supporting PCI, USB 2.0 port I/O connections 228, super I/O devices 229 such as a LPT printer port, a BIOS (Basic Input Output System) and RS-232 communication, and providing standard interfaces to hard-drive memory (e.g., IDE, EIDE, ATA and like formats) for attaching devices including, but not limited to: magnetic and optical disk storage technology including CD-ROM, DVD-ROM drives, tape drives, and large-capacity floppy disk drives. The CLE266 supports a high-speed (e.g., 266 MB/s) link between the chips 211 and 212. One interface in particular supported by the chip 212, is an extremely fast IDE interface 222 connects with ATA-133 FastDrive™ technology, that is capable of handling increased data transfer rates.

Further, the STB 200 is equipped with the following components/interfaces: a physical network LAN connection supporting IEEE802.3 (wire) or IEEE802.11 (wireless) international standard, 10/100 Base-T Ethernet PHY connection, and all standard network protocols such as TCP/IP, FTP, SNMP, etc., for example, a 6 channel AC'97 codec 232, for example for providing high-quality audio, audio jacks 233 for providing connection to an audio speaker system (not shown), an MC'97 modem connection 234 for further Internet connectivity; and PCI slots 240 for connection to peripheral devices (not shown). Further provided for supporting streaming video applications is a hardware video decoder device 250 (such as Realmagic's EM847x) adapted for decoding DVD/MPEG-2, -4 streams. The video decoder 250 receives a video feed from a conditional access (CA) demultiplexer device 260 which, according to digital TV standards, e.g., DVB-C, 8VSB, ATSC, and the like dependent upon the market, is enabled to select one from several video inputs 235 including cable, which provides a program in accordance with the setting of a digital tuner device 255, a Color, Video, Blank, and Sync (CVBS) composite analog signal or S-video (Y/C) from broadcast or cable or IPTV sources. Thus, the demultiplexor accepts compressed video MPEG-2/-4 or other like broadcast streams from a cable or network, breaks the stream into its components, and directs these components to the appropriate handling function video decoder, or microprocessor elements.

### STB Software Architecture

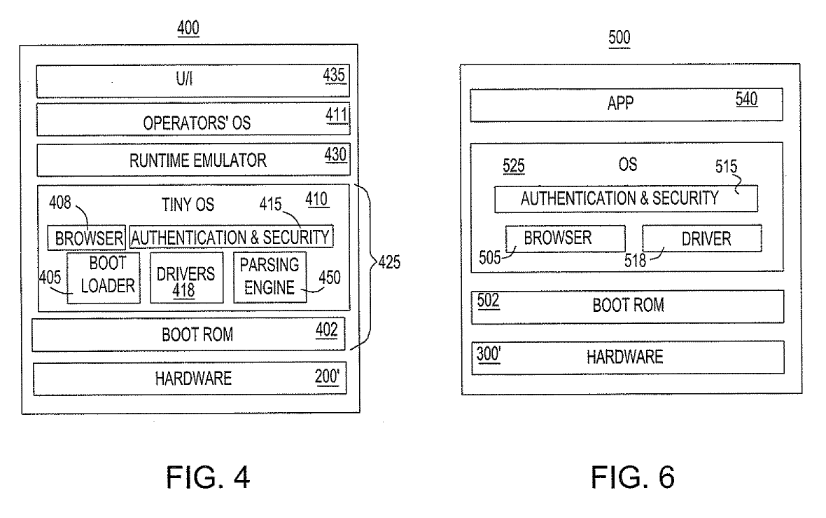

Continuing to FIG. 4, there is depicted software architecture 400 for the TVMate STB system 200 of the invention. As shown in FIG. 4, the software architecture is supported by the hardware layer 200′ including the CPU 205, the “North-bridge” chip 211 interfacing with the CPU, DDR memory subsystem and providing the dual monitor (including television signal) outputs 220, and the “South-bridge” chip 212 as described herein with respect to FIG. 3. An intelligent service gene (ISG) layer 425 comprising: a Bootable ROM element 402; and, a skeleton operating system, hereinafter referred to a “Tiny O/S” 410 that includes a browser module 408 for receiving and rendering marked language web pages, for example. Particularly, as will be described in greater detail in connection with the Tiny O/S, upon booting up the STB 200 in one embodiment, via browser module 428, the user will be automatically navigated to a predetermined web-site which will enable a user to select an Operator associated with an IPTV, a cable network, and/or EPG affiliate, depending upon the desired operating mode, e.g., conventional cable broadcast mode, broadcast EPG more, or IPTV mode. Additionally, the Tiny O/S is flexible in the sense that it initiates and enables downloading to RAM of a further Operator operating system (operator O/S) suitable for the desired operating mode, e.g., specific cable operator's O/S for cable mode, an IPTV O/S for IPTV mode, or broadcast EPG for broadcast network TV programming and EPG mode. In one embodiment, an OS download for IPTV is based on Point-to-Point transfer, not a streaming broadcast. Thus, as will be explained in greater detail, the STB 200 of the present invention is operable with different operators as opposed to conventional STB devices that typically are not off-the shelf, but rather come bundled with only one operator. Further details with respect to the operation of the flexible and Tiny O/S will be described in greater detail hereinbelow. The Tiny O/S 410 further includes an authentication and security sub-system 415; a boot loader 405, and a driver element 418 for driving all hardware chip and providing an interface to the higher level O/S. As shown in FIG. 4, in addition to the browser module 40, the Tiny O/S 410 further includes the parsing engine 450 for parsing out content that is destined for the panel remote device 300 in the manner as described herein.

The STB software architecture 400 further includes: a User Interface (U/I) layer 435, a Runtime Emulator layer 430 and, the downloaded operator OS 411, which for example is configured to run on top of the emulator. The runtime emulator 430 in one embodiment interprets all operator OS code. For example, it translates object code that is the downloaded operator OS 411 into machine code that can run on the STB's hardware platform, preferably with high efficiency. The runtime emulator 430 in one embodiment functions like a virtual machine, such as a Java® machine. The emulator 430 in one embodiment is designed and implemented to interpret different operator's OS such as Linux WinCE, Vxworks, etc., and translate them into standard machine code to run on STB's hardware platform. Different emulators may be implemented for different operators' OS or an emulator family may be implemented for interpreting different OS. The STB software architecture 400 may also implement an application layer which may execute application programs such as e-commerce, on-line gaming, P2P applications, etc. For instance, application programs on the application layer such as user interface programs 435 and picture players allow users to watch videos, click on hyperlinks, type messages, etc. For example, U/I 435 may provide a communication interface between application and input device, similar to a windows interface, with operators' OS located between runtime emulator layer 430 and U/I layer 435.

### Panel Remote Hardware Architecture

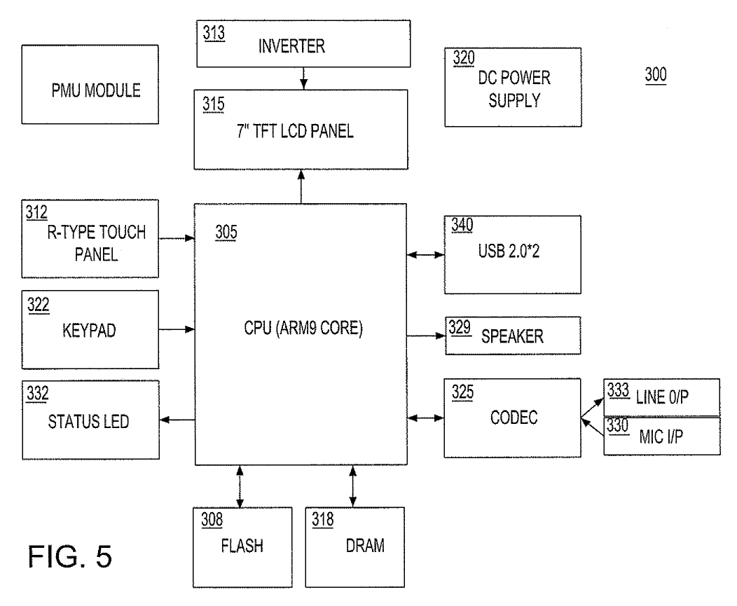

One embodiment of the Panel Remote 300 configured for interactive browsing, is shown in FIG. 5. Basically, as shown in FIG. 5, the panel remote includes a CPU 305 such as the ARM9 processor having a reduced instruction set suitable for all compute functions for hand-held digital products, a memory including Flash 308 for storing program code, for example, and DRAM 318 memory including a memory management unit that supports operating systems such as Windows CE, Symbian OS, Linux, Palm OS, etc. The panel remote 300 additionally includes an R-type (“Resistor” type) touch panel interface 312 to operate, the device by a stylus or finger, and a keypad 322 for hot key application. A small form factor TFT (Thin Film Transistor) or like LCD panel display 315, e.g., about 7 inches in one embodiment, is additionally provided for comfortable viewing of advertisement and other web content while the television is otherwise displaying a TV broadcast or digital content presentation via the Internet. It is understood that the LCD panel display is not limited to a size of 7 inches, however, it has been determined that the viewing display area provided by a panel of this size provides for most comfortable viewing from the user standpoint. A typical power source is provided, such as a DC power supply for converting home using AC voltage (220/110V) into 12V DC and a Power Management Unit (PMU) module for supplying different voltages to IC components of the PR as necessary. A DC-AC converter device 313 is additionally provided for converting DC voltage into high AC voltage to light the LCD panel 315.

A coder/decoder device, i.e., codec 325 is provided that interfaces with the CPU for providing A/D and D/A functions, for example, receiving a microphone input signal 330 and providing a line output signal 333. An audio output or speaker output interface 329 is provided as is a USB port 340 enabling “plug and play” functionality via the remote for connecting accessories (such as a card reader, USB disk drive, etc). A status indicator element 332, e.g., a light emitting diode, is also provided for indicating device status to the user, e.g., an indicator to show if power is on or off, and if the network is online, and if it is streaming.

It is further understood that wireless communication and associated authentication and security devices are provided to enable wireless communication with the STB via one or more modalities including Bluetooth, or Wi-Fi (IEEE 802.11 specification), and IrDA (Infrared) or like short range wireless transceivers. Preferably, all communications between the Panel Remote and the STB are encrypted so that the wireless part of the STB doesn't communicate with just anybody, but, rather, only communicates with a panel remote that corresponds to the user's STB. This is particularly useful in an urban or suburban setting, where wireless devices can often pick up signals from a neighbor's devices. With this architecture, content providers are assured that their content is incapable of being received unintentionally by a Wi-Fi enabled laptop. In one embodiment of the invention, when the STB is off, it cannot communicate with the panel remote with WiFi. Consequently, the remote may use IR to turn on the STB. When the STB is on and ready, a wireless connection enabling communications between the remote device and the STB is set up. The remote device 300 has a universal learning feature, so it can operate as a TV remote, or a stereo remote, or other applications, all within the same unit.

### Panel Remote Software Architecture

Continuing to FIG. 6, there is depicted the software architecture 500 for the Panel Remote device 300 of the invention. As shown in FIG. 6, the software architecture 500 is supported by the hardware layer 300′ that includes the CPU 305 as described herein with respect to FIG. 5, and, a Bootable ROM element 502. A standard operating system 525, is pre-installed such as MS Windows or Linux and sits on top of the hardware layer. The OS 525 includes functionality including but not limited to: an authentication and security sub-system 515; a browser element 505, and a driver element 518 for enabling all hardware operations and providing an interface to the OS 525. Finally, an application layer 540 is provided in which applications are executed. Thus, applications for the Panel Remote device 300 may be specialized, such as Microsoft Office, Internet browser, Picture player, etc., however may include other applications including, but not limited to: the memory card reader, text browser, a digital album storage and presentation system, an electronic program guide (EPG) application, etc. It is through these applications that a user is enabled to watch videos, click on hyperlinks, type messages, etc. The Panel Remote device 300 may be rechargeable and may include additional features such as a remote locator, for instance, for locating the panel remote in case it is misplaced or separated from the STB, and other features equipped in the like devices.

### Tiny O/S Boot Process, Flex O/S and Download Operations

The set top box (STB) of the present disclosure is enabled to handle multiple media such as cable, satellite, digital broadcasts and IPTV (Internet Protocol Television). In addition, STB of the present disclosure can download any cable or satellite operators' or providers' operating system (OS), and therefore is considered as flexible operating system set top box (Flex OS STB). For example, a user who lives in Chicago and subscribes to RCN Cable can download RCN's OS and its electronic programming guide (EPG) to the STB of the present disclosure. If the user then moves to Los Angeles where COX is the cable provider in that area, the user can connect to the COX cable system and download COX's OS to the user's STB. The previously loaded RCN OS would be deleted from the STB. If there are several service providers in one location, a user is provided with a choice to select from the list of service providers.

With the STB of the present disclosure, the cable companies or the like need not issue new boxes. A consumer need not have to switch boxes every time he or she moves to a different location or switches to a different operator. Because it has the capability to receive or download and run software or objects from any cable operators, delay time for setup is eliminated. The STB of the present disclosure in addition may include a parsing tool to split and redirect appropriate data and media to the proper devices such as the television and panel remote.

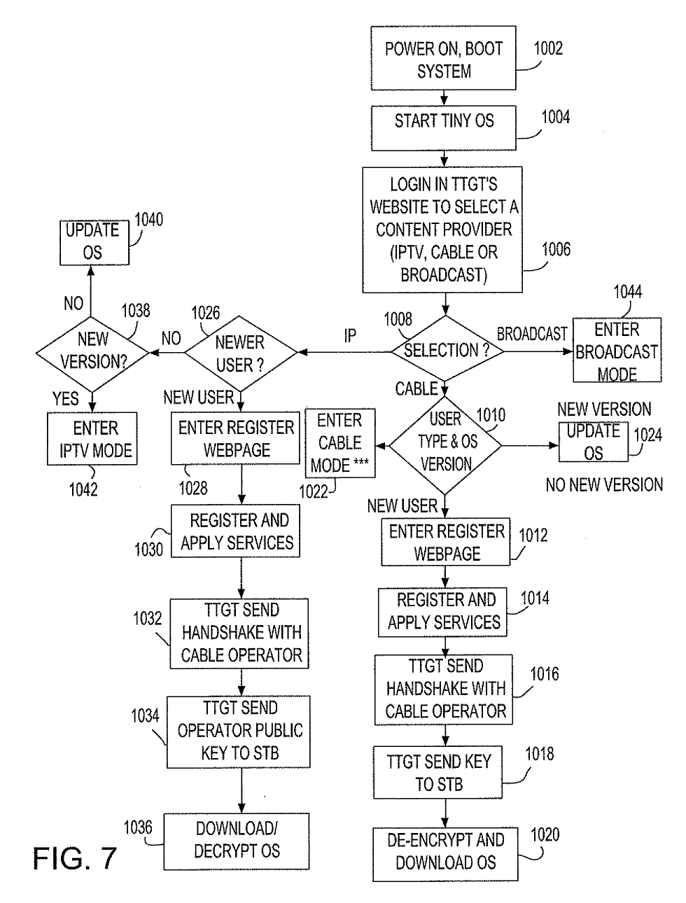

FIG. 7 is a flow diagram illustrating a method of operating the flexible operating system set top box of the present disclosure in one embodiment. A user purchases flexible operating system set top box of the present disclosure (herein referred to as STB), for instance, from a retailer, online, through a cable provider, through a satellite provider, or any other way or means. The STB includes connection ports for connecting to cable or satellite providers, Internet access, and one or more display devices. Thus, a user connects the STB, for example, to cable connection, DSL and to television, for instance at a user site such as his or her home. At 1002, the STB is powered on and the boot system initiates. At 1004, a small operating system resident on the STB, referred to as Tiny OS, starts. Tiny OS automatically connects the STB to a server system of the present disclosure, herein referred to as TTGT. In an exemplary embodiment, the server system with which the STB connects and communicates includes operation support system of the present disclosure. The connection to the server system in an exemplary embodiment is via the Internet connection, for instance, the DSL. Tiny OS, for example, allows the user at STB to connect to TTGT, login and select a service. For instance, in an exemplary embodiment, Tiny OS after booting up the STB presents one or more TTGT web pages to allow the user to login and select a desired service. For example, Tiny OS and boot ROM resident in the STB automatically connects to a login page when the STB is turned on and plugged in for the first time. A user may be able to access this page again at anytime after the initial set-up, for instance, by using a hot key, for example, that may be located on the back of the STB.

At 1006, a user logs into the TTGT, for instance, using a login web page. At 1008, a user is given an option to select a desired service. In an exemplary embodiment, available services include, but is not limited, to cable or satellite service, broadcast service, and IPTV (Internet Protocol Television) service. If at 1008, a user selects cable or satellite service, a determination is made as to whether the user is a new user or a previously registered user at 1010. If the user is a previously registered user, it is also determined at 1010 whether the version of the operating system the user's STB has is an updated version. For example, logic in Tiny OS resident on the STB may check the operator's OS previously downloaded on the STB, determine the type of operator and its OS by reading the header file associated with the OS, and determine if the version installed on the STB is the latest version for this operator. If the version is not the latest version, STB communicates with the TTGT, which in turn would notify the appropriate operator and request to begin downloading its latest version of OS to the STB. On the other hand, if the version of the OS existing on the STB is the latest version, the STB runs that version. In one embodiment, if the user of the STB desires to override this automatic process of using the previously downloaded OS, for instance, because the user would like to switch to a different operator, the user may press a soft hot key or a physical button on the STB to switch the operator or retrieve cable or satellite service page. In another embodiment, a reset procedure or button allows a user to load different operator's OS.

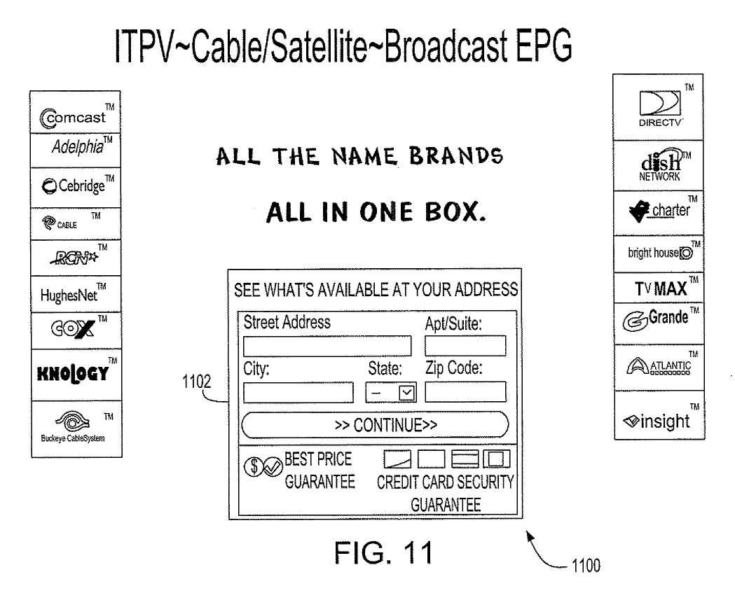

FIG. 11 shows an example of a web page screen shot that a STB user may see when he or she logs in to the system of the present disclosure. The web page 1100 allows a user to enter his or her address information, for instance, using an input form 1102. This information is used to determine the different media services available in the area associated with the input address information. In one embodiment, TTGT receives the address information and dynamically determines the available media services and operators, for instance, by looking up a database containing information about various operator services and locations. In another embodiment, STB may make the determination using media service operator information that may be stored on the STB. In one embodiment, this page 1100 may follow another page that allows a user to select a type of operator service, for example, cable/satellite, IPTV, or broadcast EPG. In another embodiment, this page 1100 may precede such a selection page. In the formal example, one or more pages following this page 1100 may then list only the available cable/satellite operators since the user has already chosen cable/satellite service. In the latter example, one or more subsequent pages following this page 1100 may list all of the available service operators, for example, cable/satellite, IPTV, or broadcast EPG. It is noted that the order in which various information is retrieved from a user is not important. Rather, any number of methods may be utilized to obtain information for allowing a user to select a service and providing that service.

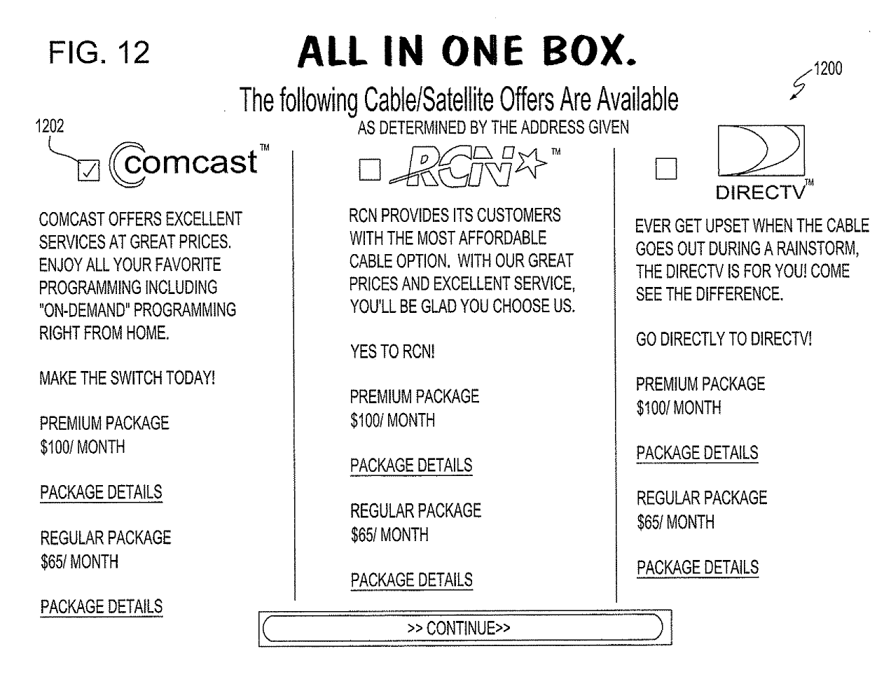

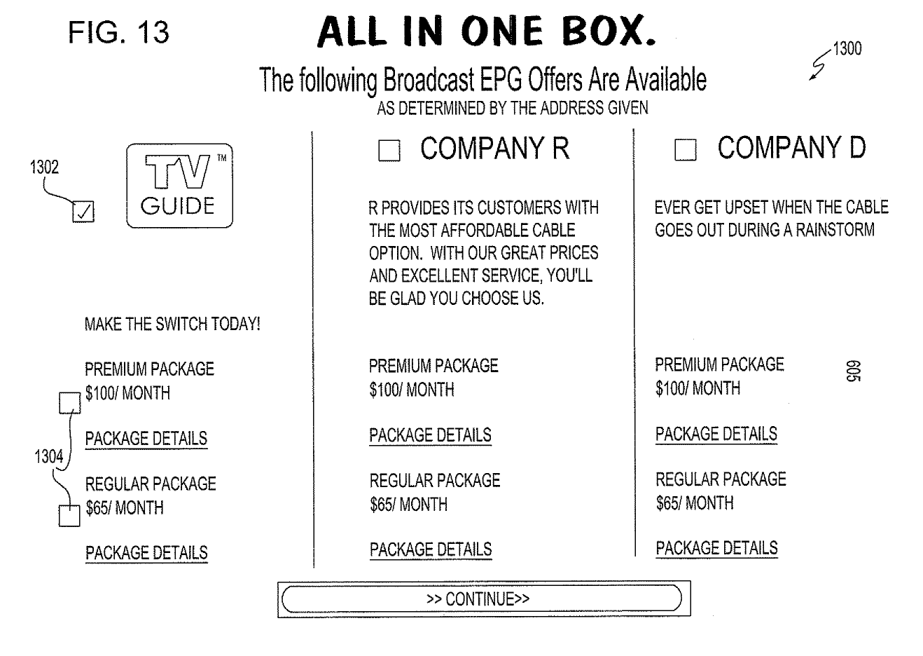

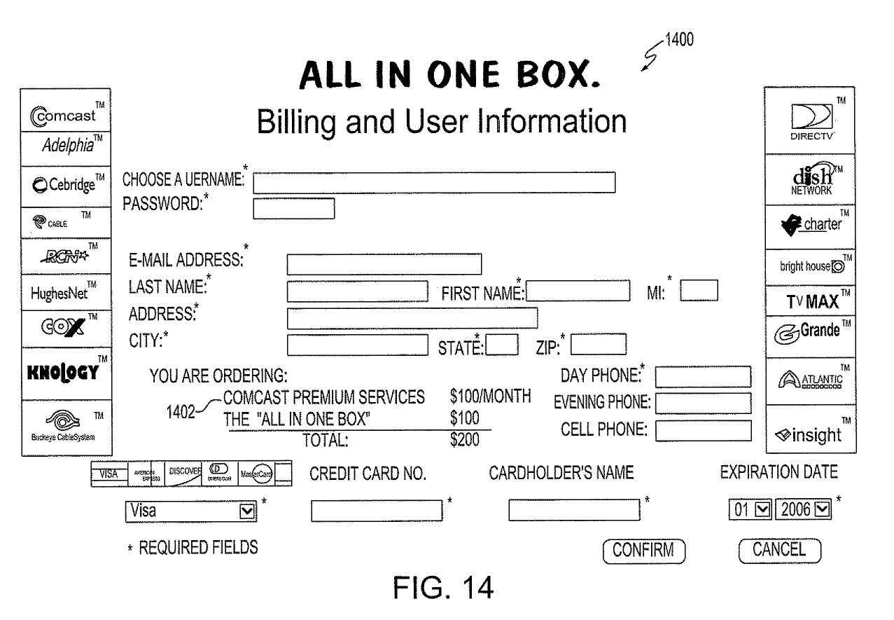

In one embodiment, selecting a cable or satellite service will connect a user to a page such as the one shown in FIG. 12. FIG. 12 shows an example of a web page that may be presented to a user for selecting cable or satellite operator. This page may be presented, for instance, for a user to select an operator from the list of available cable and/or satellite operators in the area where the user is located or has indicated with the address information of FIG. 11. This page 1200 displays a list of cable operators available to the user according to the user location. A user may select as shown at 1202 a desired operator on this page. This page 1200 may also include one or more hyperlinks so that a user may for example select one of the listed cable providers, navigate to additional pages and view further details on different cable operators, select different packages associated with a cable or satellite operator. Similarly, for allowing a user to select a desired broadcast EPG operator, STB may display a page 1300 such as the one shown in FIG. 13, for instance, via its browser. FIG. 13 is an example screen shot of a web page that may be presented to a user for selecting broadcast EPG operator. The page 1300 lists available broadcast EPG operators in the area indicated by the user. A user may select as shown at 1302 a desired operator on this page 1300. On this page 1300, a user may for example select different packages 1304 available from the different operators. It 1300 may also include one or more hyperlinks so that a user may for example select one of the listed broadcast EPG operator, navigate to additional pages and view further details on different broadcast EPG operators, select different packages associated with different broadcast EPG operators. FIG. 14 is an example screen shot of a web page that may be presented to a user for collecting user and billing information for the service selected. This page 1400, for example, allows a user to enter additional user information and billing information, for instance, if not previously entered, using various input fields on the page, and displays the user's selections and prices for the services selected as shown at 1402.

In one embodiment, a server such as TTGT web server may provide the web pages shown in FIGS. 11-14 or any other user interface for guiding a user through the selection process and retrieving information from the user for setting up the STB. TTGT may create a customer database using the information collected during this selection process. TTGT also sends this customer information and associated billing information to the operator or distributor that the customer selected. In addition, TTGT sends a request to the operator for authorization to provide the public key to the customer, which public key the STB uses to decrypt the operating system code downloaded from the operator. Once TTGT receives the operator or distributor's authorization to distribute the public key, the STB at the user can receive the distributor's OS.

Referring back to FIG. 7, at 1012, a new user may enter a website to register and apply for a service at 1014, for instance, using web pages such as those shown in FIGS. 12-14 or any other user interface. At 1016, using the information entered by the user, TTGT performs handshake with the selected cable operator to request authorization and downloading of OS as explained above. As part of the handshake, TTGT receives a public key from the selected cable operator, which TTGT sends to STB at 1018. Alternatively, the key may have been received previously from the service operator. STB uses the key to decrypt and download the cable operator's specific operating system to STB at 1020. If at 1010, the user is already registered and has desired service operator's (e.g., cable or satellite operator) latest version of operating system already downloaded to STB, cable mode is entered at 1022, and the user may view cable programs as usual. At 1024, if the user is already registered but requires a new version of an operating system from the desired cable or satellite operator, the operating system is updated, for instance, by the TTGT performing a handshake with the appropriate operator to allow STB to download the newer version of the operating system.

At 1008, if a user selects IPTV mode, it is determined whether the user is a new user at 1026. If the user is a new user, a new user registration page may be presented to the user at 1028. At 1030, the user may register and apply for IPTV service. At 1032, TTGT performs handshaking with IPTV provider. In one embodiment, as part of this handshaking, TTGT may send the customer information pertaining to the user to the selected IPTV provider and a request to download the provider's operating system to the user's STB. In turn, the provider may send authorization and/or approval to TTGT for providing the IPTV service to this user. At 1034, after receiving IPTV provider's authorization, TTGT sends the operator public key associated with this IPTV provider to STB. TTGT may have received the operator public key from the IPTV provider during the handshake stage. Alternatively, TTGT may have received the key previously from the operator. At 1036, IPTV provider's OS is downloaded to the user's STB and decrypted using the operator public key. IPTV OS on the STB is then enabled to communicate with the IPTV provider and provide IPTV services to the user. At 1038, if it is determined that a user requires a new version of the IPTV OS; the OS is updated at 1040. If not, IPTV OS already downloaded to STB for registered user is used to enter IPTV mode at 1042 and provide IPTV services to the user.

At 1008, if a user selects broadcast service, broadcast mode is entered at 1044. In one embodiment, if broadcast mode is selected, the user may be redirected to an EPG (electronic program guide) choice site, for instance, managed by TTGT, similar to TTGT's choice page for content or cable distributors. A user may enter his or her location indication such as the ZIP code and select from among the available EPG providers. The user then may be ready to start television viewing. In one embodiment, user's location indicator such as the ZIP code may be stored on the STB until changed manually. It may be stored in the flash memory. In this mode, the STB operates like a television set that receives broadcast signal with embedded metadata. The STB parses the signal and may send audio and video to a display device such as the television that may be connected to the STB, and send data such as interactive advertising to a panel remote device that may be connected to the STB.

In one embodiment, the broadcast mode of the present application described above takes advantage of the digital broadcasting technology wherein television sets will be able to receive not just television content, but also other digital information. For instance, data that is encrypted with metatags could be received by a digital television. With this digital standard, TTGT in one embodiment is able to adapt its cable STB and panel remote to receive broadcast television. The STB is enabled to receive a digital broadcast stream, for instance, comprising content, data, text, image files, etc. In the STB, this data stream may be demultiplexed, for instance, similar to a digital cable stream. Following the demultiplexing, television content is sent to the television, while the remaining data is transmitted to the parsing engine and then on to the panel remote, for instance, via wi-fi/Bluetooth technology or any other known or will be known transmission mechanism. This remaining data may be presented on the panel remote as interactive advertising, hyperlinks, and Broadcast EPG.

To enable broadcast mode in one embodiment, there is at least one affiliated partner that designs the EPG. The affiliated partner then may download the EPG to the STB, for instance, via an Internet connection, at the request of TTGT when, for example, the user selects the broadcast mode. Since Broadcast Networks operate on different local frequencies throughout the nation—even differing within the same state or region—the affiliated EPG partner provides different programming guides for the different channel lineups. Once the EPG affiliate has created the program guides and knows which localized guide to send to a user, the EPG can be downloaded to the STB. The EPG then can be viewed on the panel remote connected to the STB. Users will be able to view the channel lineups in their selected region, just as they would if they had an EPG provided by cable or satellite. The EPG provides channel listings, program summaries, ratings, etc. Users are enabled to click on a program listed on the EPG, and the panel remote will act as a remote control, changing the channel. FIG. 17A and FIG. 17B show an example of displays on a panel remote when the user selects broadcast mode. If the user's STB is equipped with DVR, VOD, or NVOD, then the EPG can also be used to instruct the STB which program to record for immediate or later viewing.

In one embodiment, the EPG affiliate need not know which program guide to send to the user. Rather, at initial setup, the user may first connect to an Internet line to the STB and begin configuration. During the configuration, the user may be asked to enter his or her ZIP code. The user may also be prompted to select one of the following options: Digital Broadcast, Digital Cable, Digital Satellite, or IPTV. If one of the last three options is selected, the user may continue to configure his or her system. If, however, the user selects Digital Broadcast, then the user may be prompted to choose from among the available EPG affiliates. After the user selects an EPG affiliate, the STB can immediately display content from the selected EPG affiliate, for instance, over the IP network. The ZIP code may be sent to the selected EPG affiliate to provide the correct information for the program guide. The panel remote, or the STB, or the combined unit remembers what ZIP code the user entered, for instance, using simple cookies, so that the user does not have to re-enter the ZIP code every time the system is turned on. If the user does not have, or loses the panel remote, the STB may still receive the digital broadcast and meta-tagged data (EPG, interactive ads, hyperlinks, etc). The user, however, may not be able to see this information until he/she obtains a panel remote.

Unlike the conventional digital broadcast televisions, the STB of the present application is able to receive interactive content, including EPG and advertising. EPG provides broadcast users with a service previously unavailable to them, for instance, the ability to view channel lineups in advance and instruct an STB to tune to those channels or record them for later viewing. The STB of the present application also allows users to be able to view one channel while recording another using the EPG. The advertising and hyperlinks are interactive to the user, for instance, with an Internet connection. A panel remote associated with the STB may display the advertisements and allow a user to access the Internet and conduct e-commerce or other Internet functions, for instance, without disturbing the user's television viewing experience. The STB of the present application provides convenience to the consumer since, for instance, it enables the consumer to upgrade or downgrade the service received at any time without incurring equipment penalties.

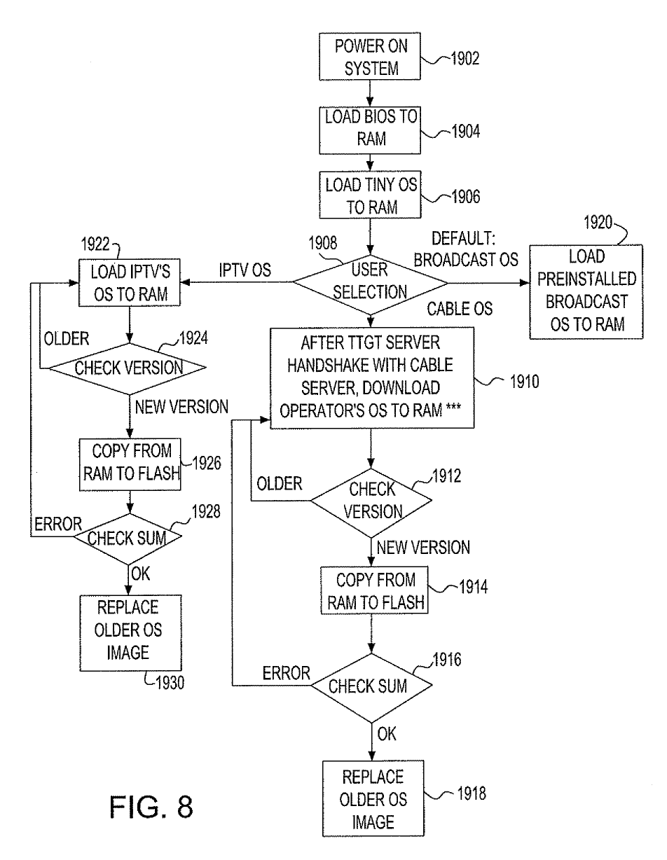

FIG. 8 is a flow diagram illustrating a method of downloading media operator's (such as cable, satellite, etc.) operating system to STB of the present disclosure in one embodiment. At 1902, STB is powered on. At 1904, BIOS resident on STB is loaded to RAM. At 1906, Tiny OS resident on STB is loaded to RAM. At 1908, a user selects a desired service. As described above, this selection may be made using a web page downloaded from TTGT by Tiny OS and displayed on a display panel connected to STB. At 1910, TTGT performs handshake with the selected cable operator, for instance, if the user opted for cable or satellite service or the like. If a version of the OS for this selected cable operator exists on STB, a check is made to determine whether that version is the latest at 1912. If not, a newer version is downloaded to STB and copied to Flash memory at 1914. At 1916, if the OS downloaded without error, any existing older version is replaced at 1918. At 1908, if the user selected IPTV service, IPTV's OS is downloaded to STB at 1922. If the OS already exists on STB for the IPTV service, a version check may be performed at 1924. Newer version of the OS may be downloaded at 1926 if later version of the OS is available. At 1928, if no errors occurred, older version of the OS is replaced with the newly download version.

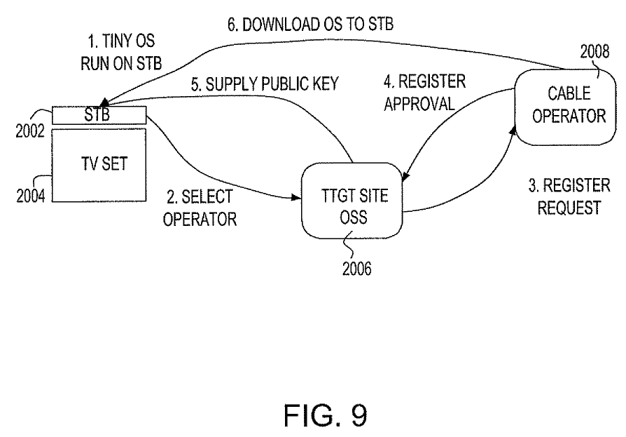

FIG. 9 is a block diagram illustrating downloading of operating systems from selected service providers in one embodiment. STB 2002 of the present disclosure, for example, may be connected to a TV set 2004 and include Tiny OS running on STB 2002. STB 2002 allows users to select a service operator such as cable or satellite operator. The selected operator is then communicated to TTGT 2006 of the present disclosure. TTGT is a server system that may include operation support system (OSS) for providing various services. TTGT 2006 then communicates with the selected cable operator 2008 to register the user for the cable service. For instance, similar information currently employed to register for a cable service may be provided to the selected cable operator 2008 to register the STB. Cable operator 2008 approves the registration and supplies a key for decrypting its data. TTGT 2206 in turn provides the key to the STB 2002. Cable operator 2008 also downloads its operating system to STB 2002. STB 2002 receives the downloaded data and uses the key to decrypt the operating system. The downloaded operating system is stored on STB 2002. STB 2002 with the downloaded operating system is now fully function to provide media services such as the cable services from the selected operator.

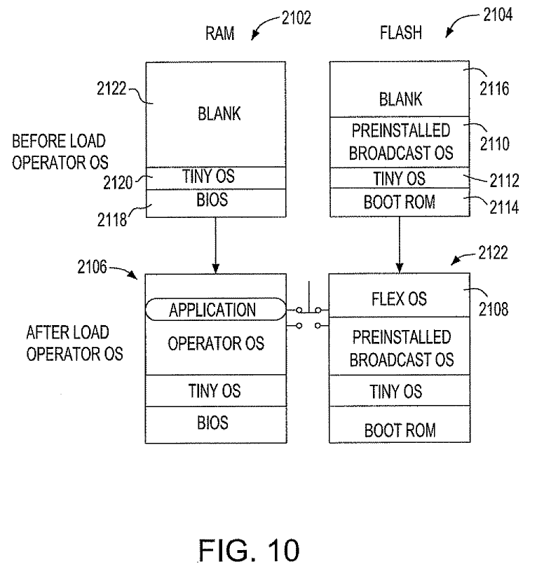

FIG. 10 is a block diagram that illustrates contents of STB memory. In one embodiment, STB initially includes preinstalled broadcast OS 2110, Tiny OS 2112, and Boot ROM 2114 in the Flash ROM 2104 portion of STB's memory. Additional memory area is provided 2116. In one embodiment, the STB may include preinstalled broadcast OS 2110 used for receiving TV programs from broadcasting networks. Since broadcasting TV programming in the United States share the same standard, one universal OS for receiving TV programs from various networks is preinstalled in the STB. However, the STB initially has no particular operators OS or applications such as cable or satellite operator's OS. When STB is powered on for the first time, BIOS 2118 and Tiny OS 2120 is loaded into STB's RAM 2102 from Flash ROM 2104. Tiny OS then communicates with a user and TTGT in allowing the user to select an operator (for instance, cable operator) and be able to download the appropriate OS and application(s) from the selected operator to his or her STB. In one embodiment, specific operator's OS and application (s) may be downloaded into RAM as shown at 2106. The downloaded OS may be stored in Flash ROM as shown at 2108 as Flex OS 2122, so for example, the downloaded OS stays resident in STB even when it is powered off.

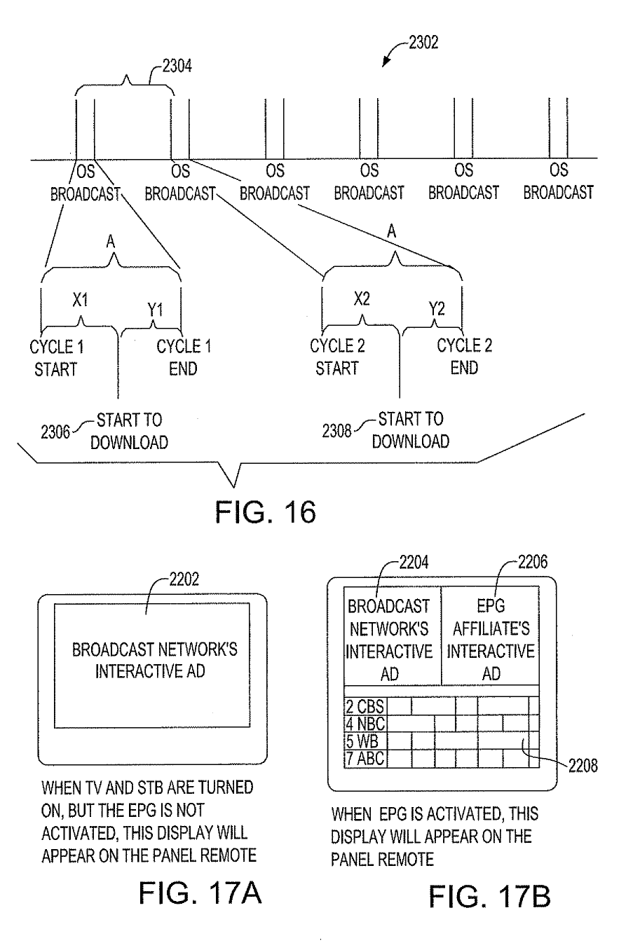

In one embodiment, content providers such as cable or satellite operators may download their operating systems to the STB by continuously streaming the data. For instance, a cable or satellite operator may provide a separate channel for broadcasting the OS content periodically. FIG. 16 illustrates a schema for streaming data from an operator in one embodiment of the present disclosure. As shown, an operator uses a separate or dedicated channel 2303 for streaming OS data. In this example, OS is streamed, shown at 2304, every 15 minutes for 1 cycle. It may for instance take 15 minutes to download a complete OS. If a user begins receiving the OS at some point between those 15 minute intervals, a tag may be placed to mark the start of downloading. The portion of the download that was missed may be downloaded in the first part of the subsequent streaming interval, for instance, the first part of the next 15 minute interval, and combined with the portion from the previous 15 minute interval. In this scheme where the streaming is continuous, the total download time is fifteen minutes regardless of what time a user starts downloading. Referring to FIG. 16, if a user starts downloading or receiving the OS data at the point of streaming shown at 2306, the downloading may continue to the next cycle of streaming and complete at the point of streaming shown at 2308, and still have an intact OS file. Thus, with the continuous streaming schema of the present disclosure, a user may download or receive the OS at anytime without a need to synchronize start and stop time for downloading the data from the selected operator. With this continuous streaming example, even an interrupted download, for instance, because of a lost connection, can continue after the connection is reestablished.

In one embodiment, OS downloaded for IPTV may be based on point-to-point transfer rather then streaming broadcast as shown above for cable or satellite operators.

As more and more audiovisual information is becoming available from many sources, with such information represented by various forms of digital media including still pictures, multimedia presentations including animations and movies, video, graphics, 3D models, audio, text and speech, more specialized systems are needed for enabling this information to be efficiently retrieved and used directly by consumers. Moreover, the volume of such information is increasing at a rapid rate and it is becoming critically important to be easily to be able to search/retrieve and manage a specific digital asset comprising, for example, a computer file including the content to be managed. When users think about the entertainment industry, they tend to think about assets as a movie, video program or commercial (i.e., a completed project) that has been digitized. In reality, any piece of a project—a frame, a cell, a scene, etc.—can become a digital media asset.

The Moving Pictures Expert Group (MPEG) is a working group under the International Standards Organization/International Electrotechnical Commission in charge of the development of international standards for compression, decompression, processing and coded representation of video data, audio data and their combination. MPEG previously developed the MPEG-1, MPEG-2 and MPEG-4 standards, and is developing an MPEG-7 standard, called the “Multimedia Content Description Interface”, hereby incorporated by reference in its entirety. MPEG-7 is a content representation standard for multimedia information search and will include techniques for describing individual media content and their combinations. Thus, MPEG-7 standard provides a set of standardized tools to describe multimedia content. Therefore, the MPEG-7 standard, unlike the MPEG-1, MPEG-2 or MPEG-4 standards, is not a media content coding or compression standard but rather a standard for representation of descriptions of media content. The data representing descriptions is called “meta data”. Thus, irrespective of how the media content is represented by cable, broadcast and IPTV content providers, i.e., analog, PCM, MPEG-1, MPEG-2, MPEG-4, Quicktime, Windows Media etc, the metadata associated with this content may be MPEG-7 compliant.

Thus, as implemented in one embodiment of the invention, a metadata standard, not unlike the MPEG-7 standard, is implemented to describe attributes of a digital asset that may be needed for further processing, or that may be of interest to a user who is consuming the final product. Thus, for example, an attribute related to a digitized audio or video file could include, but is not limited to: a creation date; a creator; a file type; a name of file; size of file; project name; episode; scene; scene description; content rating (language, nudity, violence, etc.); actor(s); acquisition format; audio track characteristics frame rate; spatial resolution/aspect ratio; colorimetry and gamma characteristics processing history; composition information (e.g. related matte/alpha channels): pan and scan coordinates; motion vectors for path based animation of an overlay object; versioning information (suggested editing to meet time or rating requirements); storyline information and key scenes that can be used to generate promos; etc.

The notion of appending metadata to the digitized asset has been enabled, in part, by the migration of virtually every aspect of the content creation process to computer-based tools. Furthermore, links are built between the tools that allow the metadata to be appended to media files in a way that is virtually transparent to the artists and technicians who produce the content. In addition to the need for computer-based tools, there are two important prerequisites that enable such an approach to the re-engineering of the content creation process: 1. the ability to network all of the systems that create and process the data together so that it can be shared; and, 2. an asset management system that provides the framework for entering information about, and managing the digital assets. An asset management system is a group of software applications and subsystems that work together to form a complete system for the customer. This could contain multiple client/server applications, database systems, as well as many different types of hardware: PC, Mac, SGI, media servers, and networked video processing devices.

Broadcasters will provide a variety of “on-demand” services to their communities, both through their DTV channel and Internet Web servers. Such services providing content such as news, election returns, sports scores, the local weather forecast, program guides, city directories, restaurant and movie guides, etc. The server that feeds this information to the Web will also feed the DTV data multiplex, periodically updating information stored in the digital media servers of the “viewers.” The traditional assumption that television broadcasting is a one-way medium incapable of delivering interactive services has been rendered meaningless by the shift to digital technology. Consumers may have several back channel options for interacting with television broadcasts—telco, cable and wireless. More important, however, they may not need or want any back channel to consume interactive services delivered as data through the DTV channel. The ability to store broadcast data locally, in an information appliance, makes it possible to deliver interactive applications in much the same way that the Internet currently broadcasts data to servers all over the world. For example, using the full bandwidth of a 6 MHz DTV channel, a broadcaster can deliver 72 megabytes of data in 30 seconds. This data may include audio, video and graphic objects that are combined in the receiver to create a traditional linear television commercial—it may also include the elements of a Web page to provide an interactive experience for the viewer, such as an electronic brochure. In other words, the digital broadcaster can provide virtually any service that can be delivered by any other data network; and a wired back channel can be used to support transactions, including on-demand data broadcast services. Perhaps the most important implication, however, is that broadcasters have sufficient bandwidth to deliver high quality audio and video along with these new interactive services. Equally important, they can do this in a totally non-invasive manner. The viewer can choose whether they want to send any information back, essentially building a privacy firewall between the viewer and the service provider. This level of privacy does not exist when a consumer connects to an Internet Web site, as a record of the visit can be recorded by the Web server. Thus, it is the case that DTV is likely to evolve into an entirely new medium. As with the transition from radio to television, this medium requires a new business model; a business model that leverages the ability to broadcast data.

The best way to look at this model is through the management of the data multiplex. There are three general categories of data that may be included in the multiplex: programmed, periodic and opportunistic. Variable bit-rate coding attempts to maintain a constant level of picture quality by keeping the level of quantization fixed, and letting the bit rate increase with pictures of increased coding complexity. Typically, a decoder is set to operate with an average and peak bit rate in mind. Encoding video for release using the DVD formats provides a good example. The average bit rate is typically determined by the length of the program or movie being encoded—total capacity divided by total duration determines the average bit rate target. Peak bit rate is established by the peak transfer rate for the DVD disc—rates vary with single and dual layer discs. In digital broadcasting, an example of peak bit rate would be 19 Mbps peaks in HDTV programs encoded for a DTV channel. In DTV applications, variable bit rate coding offers a potential quality-of-service advantage by delivering consistent picture quality. It also offers a potential business advantage by maximizing the revenue produced by a DTV data multiplex. For example, a broadcaster that carries two programmed services can set the peak bit rates for each so that they do not exceed the 19 Mbps available. When they operate below these peaks—which is most of the time—any data packets left over can be used for periodic and opportunistic services.

Unlike the isochronous nature of video programs, periodic data can be delivered in an asychronous manner—when it can be fit in. A good example of periodic data is the Teletext service that is delivered in the vertical interval of PAL broadcasts in Europe. Assume a broadcaster chooses to provide advertiser supported news headlines, sports scores, weather maps and forecasts to viewers through a Web site and their DTV channel. When a DTV receiver tunes to the channel, it will receive a program map that indicates all of the services feeding the data multiplex. The receiver can set up a memory buffer to accept periodic data identified in this program map. In the context of the invention, those data is a webpage of advertisement. This data is inserted in the multiplex periodically to update information and serve new customers who are acquiring the channel. Once in memory, this information will be available to viewers on demand (full screen), or it can be displayed continuously on an unused portion of the screen (a window), or as a program overlay. The rate of update for periodic data becomes a variable, which is factored into the software managing the data multiplex. For example, weather maps may only change every hour and be refreshed every five to ten minutes for new viewers. Sports scores may be updated as they are received for games in progress.

Periodic data can also be used to provide other new revenue streams. For example, a broadcaster could deliver movie guides for local theaters, restaurant guides and printable electronic coupons. Like programmed data, periodic data can be sold and scheduled, however, due to its asynchronous nature, there is some flexibility in delivery time.

Opportunistic data has similar characteristics to periodic data. The major difference is that it may not be something that can be scheduled, or it may be data with a lower priority and thus may be sold at a lower rate. In either case, it will be delivered on a space-available basis. A good example of opportunistic data is a paging service. The message size is small and thus easy to squeeze into the limited residual packets that are left over; and there is some latitude in delivery time. Another good example is the delivery of routed data packets to wireless information appliances, for Internet type services—an appliance of this type may use a back channel to request data packets, or it may simply filter the data carried in a DTV channel, looking for information to which it subscribes.

### Metadata

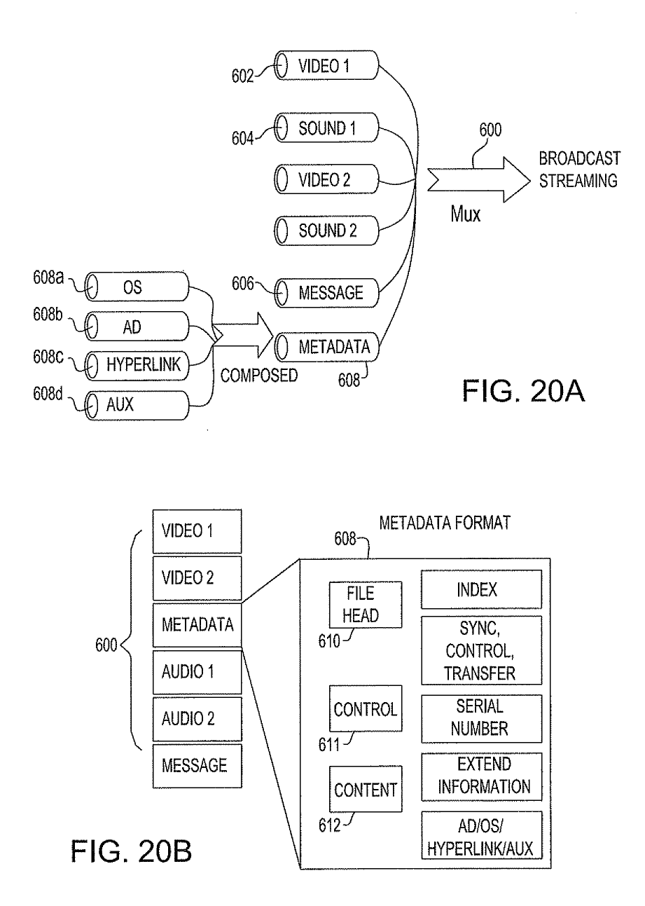

FIGS. 20A and 20B depict one embodiment of a metadata format utilized in connection with a digital media presentations received by the STB of the present invention. As shown in FIG. 20A, the media presentation, in one embodiment, is configured as a multiplexed stream 600 comprising video content from one or more sources 602, (e.g., V1, V2, etc. . . . ), corresponding audio sources 604 (e.g., A1, A2, etc. . . . ), a message portion 606 and a metadata portion 608. Although not shown, it is understood that the messaging portion is part of the standard for digital TV (e.g., DVB-C, DVB-T, ATSC, etc.) and may comprise one or more messages such as, for example, control descriptions, such as timing and synchronization, program information, decrypting information, keys information, etc. As shown in FIG. 20A, the metadata portion includes “OS” (operating system update data) inputs 608a, “AD” (advertisement(s) data including text and graphics) inputs 608b, and Hyperlink data inputs 608c. There are additionally auxiliary inputs 608d to incorporate more information in the future. Referring more particularly to FIG. 20B, the metadata portion of a streaming transmission, whether it be broadcast, cable or IPTV streaming broadcast comprises the information including, but not limited to: file header portion 610 having information such as index, sync, control and transfer that associates the metadata content with a particular broadcast; a control portion 611 including a serial number enabling reassembly of content and an indication that extended information is to follow, i.e., additional content 612 including the OS, AD, hyperlink and auxiliary data inputs is to be provided.

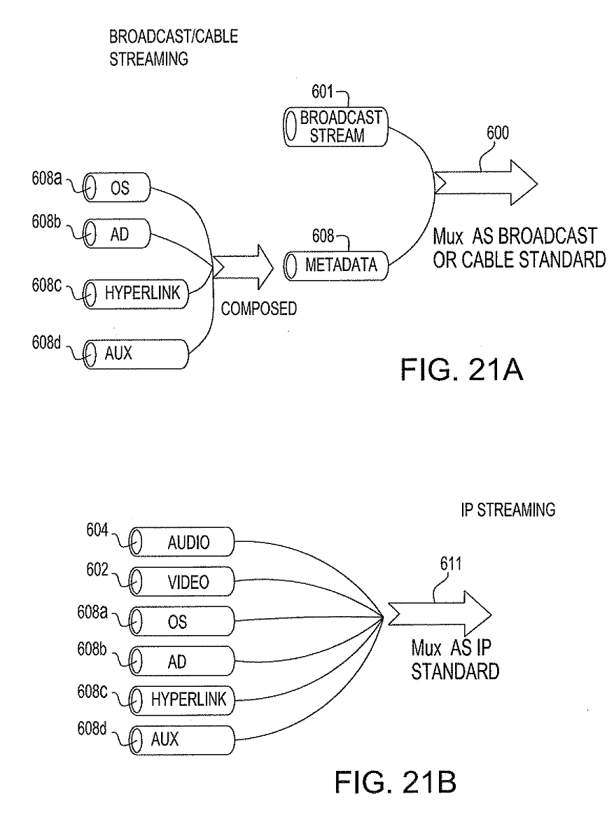

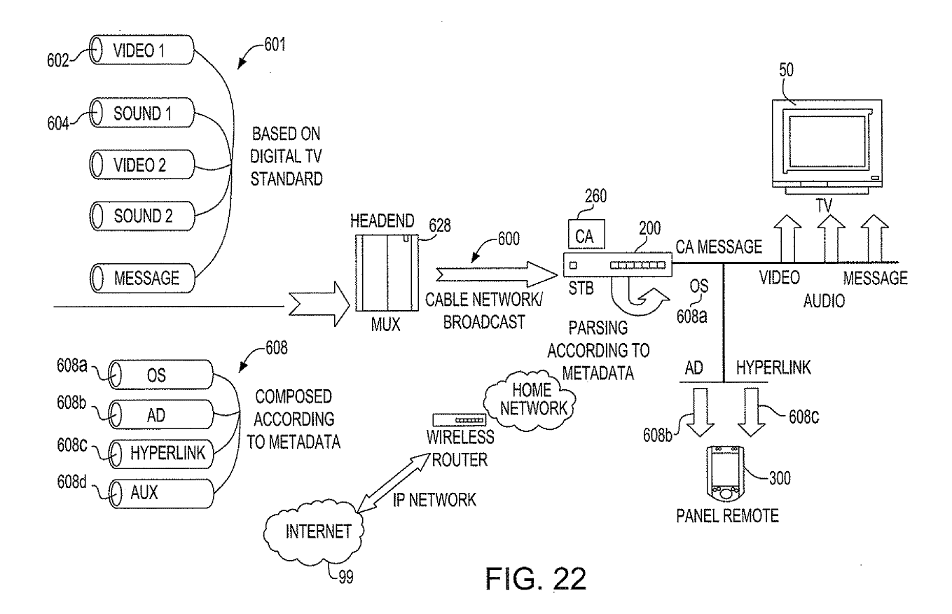

Thus, from an authoring standpoint, FIG. 21 A depicts how broadcast and cable operators will provide content that the STB device of the invention can receive. As shown in FIG. 21A, the composed metadata 608 including the additional content including the OS, AD, hyperlink and auxiliary data inputs are appended or otherwise integrated within the cable or broadcast stream 601 and fed to a multiplexer device (such as the multiplexer device 628 depicted in FIG. 22, to be described hereinbelow) where the multiplexed cable or broadcast program 600 including the metadata is streamed over a broadcast channel or cable network, e.g., according to conventional broadcast or cable communication protocols. Similarly, from an authoring standpoint, FIG. 21B depicts how IPTV operators will provide streaming content that the STB device of the invention can receive. As shown in FIG. 21B, the metadata content 608 including the OS, AD, hyperlink and auxiliary data inputs associated with the IPTV program content are multiplexed together with the IPTV content (such as via the multiplexer device 628 depicted in FIG. 22) to form an IPTV stream 611 that is streamed via TCP/IP and like streaming protocols, e.g., the Real Time Streaming Protocol (RTSP), developed by the Internet Engineering Task Force.

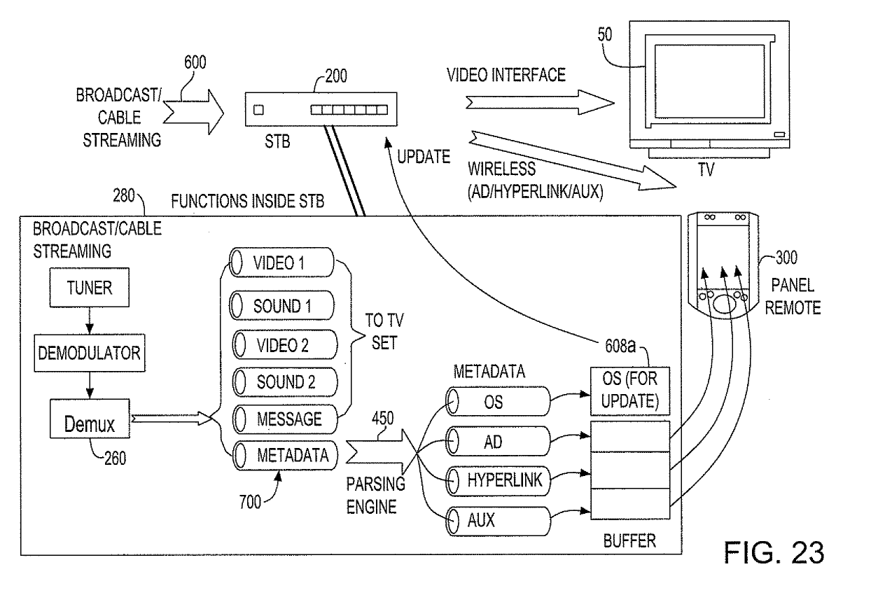

Referring to FIGS. 22 and 23, in more detail, the data stream 600 as a whole thus includes the “regular” TV content and interactive content, e.g., advertisements that may include text, and graphics and hyperlink content. There are three (3) elements that are crucial to the metadata process: the multiplexer (Mux), a streaming server, and a parsing engine provided in the STB. The mux 628, located at the headend, attaches the metadata tags to the different information that is to be part of the data stream, and then actually conglomerates the data into one stream. The interactive streaming content is encoded at the mux to include the following including, but not limited to: a file head, which is composed of a metadata tag and synchronization, control, transfer information, etc.; control information, which is composed of interactive information numbers and extra information reserved for future use, for example, by a cable operator; and the actual content. After the interactive content is thus encoded and packeted for input to the data stream 600, that data stream is maintained and sent out via a streaming server (not shown) that sends the data stream to the end user's set top box. Located within the STB 200 is the parsing engine, where the data stream is de-multiplexed by CA demultiplexer device 260 and the metadata content parsed out by the parsing engine. The data stream is de-muxed based on existing digital video broadcasting standards (e.g., DVB-S, DVB-T, DVB-C, et al.), leaving a data packet 700 that includes OS, ads, hyperlink, text, etc, and also metadata tags, as shown in

FIG. 23 detailing the processing 280 executed within the STB. This data packet then goes to the parsing engine 450, where the parsed data portion is separated and sent to its final destination. “Regular” television content is sent to the television unit 50, while text, graphics, and interactive content (e.g., advertisements and hyperlinks) are sent, e.g., via wireless communications, to the panel remote 300. For example, the parsed data portion may be temporarily buffered in a memory and output to a communications module (not shown) in the STB where it is modulated and the data transmitted wirelessly to the panel remote device 300. As shown in FIGS. 22 and 23, and mentioned hereinabove, any OS data or OS code update that is needed to process content will be distributed internally within the STB 200 and utilized by the STB itself in order to configure the STB to process the remaining broadcast, cable or streamed IPTV content.

Thus, from the consumer standpoint, the dual mode display aspect of the invention facilitates interactivity with the STB as described with respect to FIGS. 22 and 23. FIG. 23 particularly depicts how broadcast TV, cable TV and IPTV operators stream multiplexed digital content 600 including the metadata content 608, and, how the streamed digital content 600 including the metadata content 608 is processed by the STB according to the invention. As a result of the processing 280 occurring in the STB, where, as described, specialized hardware components as described in FIG. 3 for utilizing MPEG-2,-4 or other compressed multimedia presentation format that provide the digital content for the STB and digital televisions is processed, the text, graphics, and interactive content (e.g., advertisements and hyperlinks) of the streamed metadata, are sent, e.g., via wireless communications, to the panel remote 300 where it is received, configured and/or formatted for display via an executing browser device on the remote 300. Thus, via the panel remote device 300, utilizing the communicated advertisements and interactive hyperlinks, users may navigate to a web-site(s) providing items related to the “Regular” television content appearing on the users TV display device 50 for a user to purchase while the television program is presented on the TV device. Alternately, or in addition, via the browser in the panel remote 300, a user may search or navigate the World Wide Web and perhaps, conduct e-commerce transactions, e.g., purchasing products on-line.

### Business Model Flow

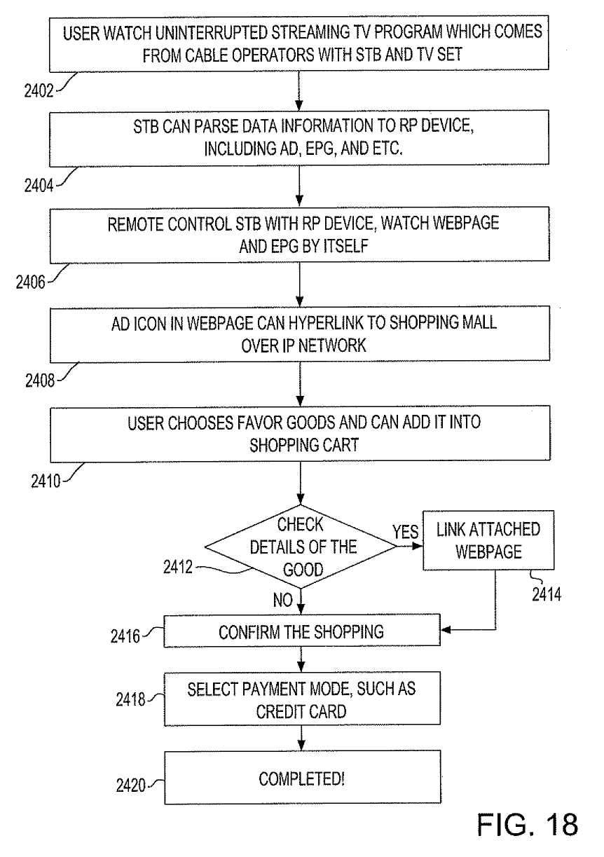

As discussed above, the STB of the present application is able to receive interactive content, including EPG and advertising. The advertising and hyperlinks are interactive to the user, for instance, with an Internet connection. A panel remote associated with the STB may display the advertisements and allow a user to access the Internet and conduct e-commerce or other Internet functions, for instance, without disturbing the user's television viewing experience. FIG. 18 is a flow diagram illustrating interactive shopping that a user may perform using the STB of the present disclosure in one embodiment. At 2402, a user may watch a program from TV programming, cable or satellite provider, etc., without interruption on a display device such as the TV set using the STB. STB, for instance, has parsed and sent the TV content to the TV set. At 2404, STB's parsed data that includes advertisements, EPG and other data is directed to the panel remote device of the present disclosure. At 2406, a user can view web pages, advertisements, EPG, etc on the panel remote device. Advertisements may be displayed, for example, as part of a web page by a browser on the panel remote. Icons associated with advertisements may be hyperlinked to shopping mall over the Internet network as shown at 2408. Thus, by clicking on the icon or the like on the panel remote, a user may perform shopping. At 2410, the user may select one or more products or goods and, for example, add them to his or her shopping cart. At 2412, a user may also be provided with an option to view detailed information associated with the selected products or goods. For instance, if the user selects the option for more information, the user may be linked to another web page that includes the information at 2414. At 2416, the user may confirm the shopping, select payment mode at 2418 and complete the shopping process at 2420. Revenue may be shared among the different players that provided this shopping procedure, for instance, TTGT or STB provider, operator or broadcast network that sent advertising data to the STB, and the seller of the products or goods.

In one embodiment, the EPG may be displayed on a panel remote together with advertising, for example, from broadcast networks, affiliates or advertising agencies as shown in FIG. 17A and FIG. 17B. This may be beneficial to increasing advertising revenues. For example, presenting the EPG on the same device such as a panel remote as the interactive content provides the user with functionality and exposure to advertisements.

As mentioned previously, an affiliated partner may create and transmit program guides in broadcast mode. Examples of affiliated partners may include but is not limited to entities such as Gemstar TVGuide, that already creates and reproduces channel listings both in print and for Cable and Satellite EPGs. Other examples of EPG providers may include Tribune TV Data (US & EU), Broadcasting Dataservices (UK), Expway (EU and JAP), and NexTView (EU).

The broadcast mode of the present application provides new revenue streams for advertisers. For instance, advertisers such as advertisement agencies, Internet selling sites, or product manufacturers may pay the Broadcast Networks to buy advertising space. They may buy traditional 30-second spots to be included in the actual broadcast and/or bid for interactive advertisement space. Interactive advertisements sold by the Broadcast Network may be displayed on the panel remote. Separately, the EPG affiliate can sell its own advertising. In one embodiment, a panel remote may display the Networks' interactive advertisements on its entire display as shown at 2202, FIG. 17A. When a user activates the EPG (by selecting an EPG button on the panel remote or from a “menu” button), the Network advertisement may shrink in size, to take up one top corner of the panel remote (FIG. 17B, 2204). An advertisements sold by an EPG affiliate (FIG. 17B, 2206) may also be displayed on the panel remote, for instance, next to the Network advertisement. The actual Program Guide may appear for the user, for instance, on the same display window, beneath both forms of advertisement as shown at 2208, FIG. 17B. In this manner, the user is able to select the EPG when desired, while the Broadcast Network is assured that its interactive advertisements will be viewed.

In the above scheme, Networks may receive revenues from companies purchasing traditional and interactive advertising space. EPG affiliates may receive revenues from selling advertisements on their EPG. TTGT earns revenues from any one or more of the following sources, but not limited to such: consumer Electronics Retailers pay TTGT for an inventory of STBs and Panel Remotes; competing EPGs pay TTGT to be listed at higher ranks on the setup page; the selected EPG pays TTGT every time a user actually selects their service; Broadcast Networks pay TTGT a percentage of all interactive advertising revenues; EPG pays TTGT a percentage of all EPG advertising revenues; TTGT may also receive revenues for every click that an interactive advertising actually generates. These revenues may be collected from whomever actually runs the advertisement, for instance, an advertisement agency or a product manufacturer or an Internet site. In another embodiment, advertisers can pay TTGT directly to bid for higher ranks in advertisement pages. TTGT may run these “search ads” as interactive advertisements on TTGT's panel remote. TTGT may receive revenues based on the highest bidder or charge based on a click-through-rate.

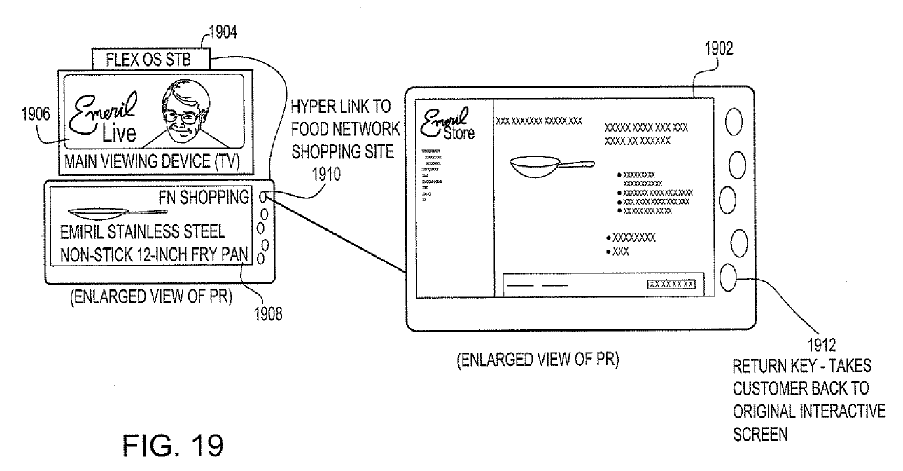

FIG. 19 is a diagram illustrating another example in which a user is able to view a TV or cable program and also purchase a product shown on the program. A customer, for example, is watching Emeril's cooking show on the Food Network Channel using the devices of the present application as described above such as the STB 1904, viewing device such as a television 1906 and the panel remote 1908 that allows interactivity. In this example, Emeril is sautéeing fish and suggests using a quality non-stick pan when sautéing. Without interruption to the viewing of the program on the main viewing device 1906, the STB receives interwoven advertising for Emeril's non-stick frying pan with a hyperlink to the FoodNetwork Shopping website, which the STB parses and displays on the panel remote as shown at 1908. Clicking on the hyperlink 1910 navigates the customer to a web page 1902 that presents detailed information on the product and allows a customer to purchase the item. The customer can, for instance, add the product to the shopping cart and proceed to check, providing payment methods on the web page or subsequent web pages. Alternatively, the customer may continue watching the show and check out at a later time. Clicking on a return key 1912 will return the customer back to the original interactive screen on the panel remote 1908.

### E-Commerce Flow

In one embodiment of the present disclosure, via wireless communications technology, the Remote device 300 will send a user's request to the intelligent STB 200 and the Parsing Engine responds to the selections by repurposing the data, e.g., as an HTML page, to provide auxiliary content different from the main content displayed on the main TV display device for interactivity, e.g., web-surf, EPG, advertisements, conduct e-commerce, etc. In this regard, the remote device 300 is equipped with a electronic card swiper mechanism 315 that enables user's to conveniently conduct e-commerce transactions by swiping that user's credit/debit card 316 in the card reader slot provided with their remote device 300, in one embodiment, or, the card reader slot provided with that user's STB device if equipped. Thus, for instance, via the remote device 300, a user can hook into Credit/Debit card system, or on-line banking or other payment system like PayPal, for example, for conducting e-commerce payments. A secured middleware component within the STB device can access either a unique “smart” IC card issued to the user (including an ID and Token and eCertificates storage) or, other IC cards issued by banks or institutions like Visa or American Express. It is understood that the hardware interface I/F could be an ISO7816-compliant card reader or may comprise a USB port for KeyStick or USB port cardReader. On top of the SecuredMiddle layer component may comprise an SSL or other cryptology technology layer(s) if required. Thus, in one embodiment, a user's Smart card is inserted in a card reader slot provided with the intelligent STB in order to identify the user. The card has the features of ID, Token and eCertificates storage.

### Revenue Flow

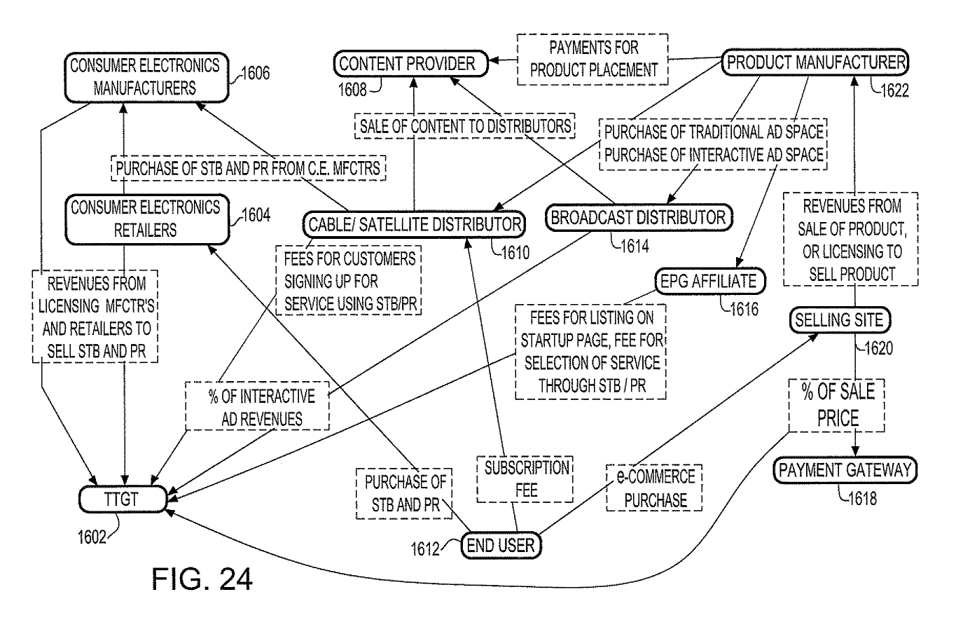

FIG. 24 is a diagram illustrating a business revenue flow in one embodiment among a plurality of components in the present disclosure. TTGT 1602, which provides the system of the present application including the OSS services and associated equipments such as the STB and panel remote (PR) devices may receive revenues from licensing manufacturers 1606 and retailers 1604 to sell STB and PR. TTGT 1602 also may receive fees associated with customers signing up for services using STB and PR, and percentage of interactive advertisement revenues from cable/satellite distributors 1610, broadcast distributors 1614, and EPG affiliates 1616. TTGT 1602 further may receive percentage of sales price for goods and services purchased by customers through the selling sites 1620 displayed on the STB/PR. Consumer electronics manufacturers 1606 earn revenue from the sale of STB and PR to for example, consumer electronics retailers 1604 and cable/satellite distributors 1610. Consumer electronics retailers 1604 in turn receive revenue from selling the STB and PR to end users 1612. Cable/satellite distributors 1610 receive subscription fees from end users 1612 and fees for selling advertisement space revenue to product manufacturers 1622. Similarly, broadcast distributors 1614 and EPG affiliates 1616 may receive subscription fees from end users 1612 and fees for selling advertisement space revenue to product manufacturers 1622. Content providers 1608 receive payments for product placement from product manufacturers 1622. Content providers 1608 also receive payment for sale of content to distributors 1610. Product manufacturers 1622 receive revenues from sale of product, or licensing to sell product from selling sites 1620. Selling sites 1620 may also provide percentage of sale price to payment gateways 1618 such as credit/debit card networks.

### OSS/TTGT

As shown in FIG. 2, an operation support system (OSS) 900 of the present disclosure also described hereinabove as TTGT, provides various services and server functionalities to the STB of the present disclosure. OSS in an exemplary embodiment supports initialization and downloading of various operators'operating systems and/or applications to STBs, downloading the a service page to STBs, authentication and security functionalities, allowing carrier service select and subscribing and unsubscribing to services, e-commerce functionalities, and other value-added operations to the media service platform such as the cable and satellite, broadcast EPG, and IPTV platforms provided by the STB of the present disclosure. In one embodiment, OSS is enabled to connect to Internet web sites, servers of telephone companies and/or cable companies and also provides management functionalities between the STBs and these Internet web sites, servers of telephone companies and/or cable companies. It handles various controls, managements, and/or interface functions to coordinate with services, customers, and/or back-end systems. Examples of services OSS provide may include but is not limited to authentication, billing, accounting and user management.

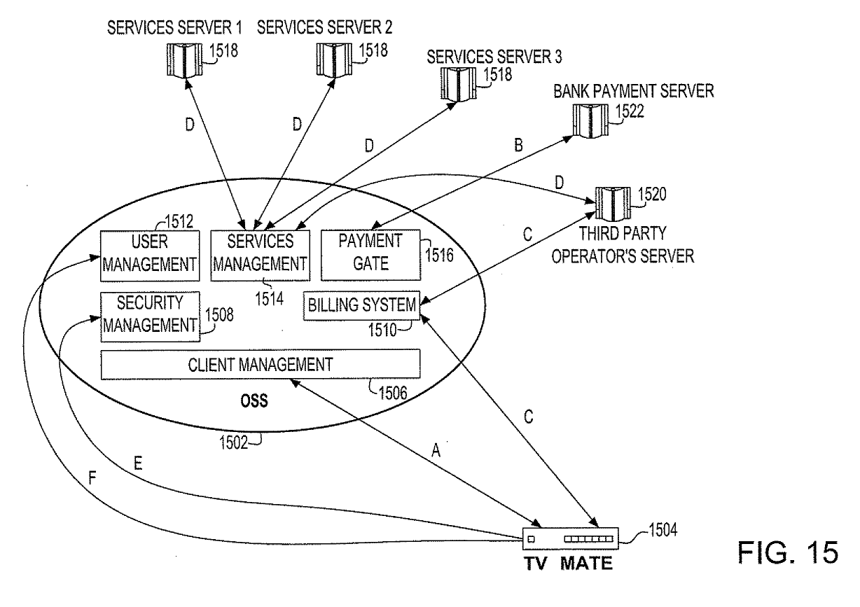

FIG. 15 is a diagram illustrating operation support system (OSS) architecture in one embodiment of the present disclosure. In an exemplary embodiment, OSS 1502 of the present disclosure is an open system that can be augmented, for example, incrementally and may be upgradable. In one embodiment, the operation support system is based on broadband network and supports popular network access methods such as XDSL, Cable-M, ATM, Router, IAN, WLAN. Any other known or will-be-known network may be supported. The operation support system of the present disclosure in one embodiment also is enabled to support existing access authentication methods such as PPPQE, IPIDNS, Web, etc. Any other known or will-be-known access authentication methods may be used in the operation support system of the present disclosure. The operation support system in one embodiment provides clients a strong and flexible registering management methods, supports broadband network services such as Internet access, electronic mail (e-mail), and value added network services such as VoIP (voice over IP), games, VOD (video on demand), Home Stock VIP room, and remote learning. In an exemplary embodiment, the operation support system of the present disclosure provides a support and value added platform for various authentication methods, integrated services and value added services.

In one embodiment, the operation support system 1502 of the present disclosure may include various subsystem components such as customer management system 1506, security and authentication system 1508, billing system 1510, user management system 1512, services management system 1514, and payment gate 1516. These subsystems are provided herein as examples only. Thus, OSS 1502 may include more or less number of subsystems than shown in FIG. 15 to perform various functionalities of OSS. The subsystems, for example, provide services such as network access, business management, real time registering, real time accounting, real time payment, customer service, terminal management, card management, and billing process.

In an exemplary embodiment, the operation support system of the present disclosure supports authentication for various accessing terminals including but not limited to authentication and security management for STBs 1504. For instance, a security management subsystem 1508 may provide authentication and login functionalities for users of the STB 1504 and other security functions. The operation support system 1502 is enabled to support various broadband digital network access methods such as SDSL, LAN, VPN, PPPQE, PPPOA, and web authentication methods and broadband access structure. The operation support system of the present disclosure may also provide customer services such as accepting submissions of terminal equipment problems and supervising troubleshooting process, for example, via a client management subsystem 1506. The client management subsystem 1506, for instance, may provide online services and customer services such as enquiry on fees, original data, and accounting data, changing personal password, providing user messaging, tracking customer complain and business trouble report, builds good-will for a business. The client management subsystem 1506 in addition may handle various STB device management functionalities. User management subsystem 1512, for instance, handles user information such as user name, address, billing information, preferences, etc. The user management subsystem 1512 may also manage user accounts with capability, for example, to open accounts, put accounts on hold, restart accounts, cancel accounts, etc. Service management subsystem 1514 manages services supplied by the system of the present disclosure, for instance, from third party operators'servers 1520 and various other service servers 1518 such as third party content provider servers or servers that provide services such VOD, VOIP, etc.

A billing subsystem 1510 services billing information, for example, about the users of the STBs 1504, communicated between the system of the present disclosure and third party operator servers 1520 such as cable, satellite, IPTV or broadcast TV operators' servers. The billing subsystem 1510 in one embodiment may calculate charges and generate bills according to chargeable data collected by data collection system and billing policy. In addition, a payment gate 1516 handles billing information communicated to and from one or more banks 1522. In one embodiment, a secure access port on the OSS allows secure communication and access to bank's payment system. The various subsystems OSS shown in FIG. 15 and their functionalities described above are provided as examples only. Thus, OSS may include more or less number of subsystems to perform various functions of the OSS. In addition, each subsystem may perform other or additional tasks as well as performing the operations of other subsystems. Furthermore, rather than having various subsystems to perform the different tasks, one subsystem may perform all tasks OSS.

The operation support system of the present disclosure in one embodiment may also provide system monitoring capabilities. For instance, it may provide real time system operation status and alarm setting and alert capabilities to smoothly maintain a system. It can seamlessly connect to other systems via for example, external ports such as XML, CORBA, etc, and network tunneling systems. In one embodiment, the operation support system may include functions such as statistics inquiry system and customer service functions, which may rely on other functions. The operation support system may also support policy decision-making. For example, it helps network operators to understand the operating status of various existing services and correctly adjust the service operating strategy. In another embodiment, policy-making support may be established on business management function. Policy-making may be supported by data warehouse technology and provide decision-making support to executives. The operation support system of the present disclosure provides the flexibility to integrate with other application systems and may become a fully functional information management system to support a business operation.

The operation support system of the present disclosure in one embodiment is fully adaptable and can be installed and run on any platform, for example, running Windows, Linux, and Unix operating systems. Its modular structure in one embodiment provides various options for users, integrated resolution to a community, a business, and network operation businesses. The scalability and extensibility of the operation support system software structure enables configuring of individual user's specific requirements. In addition, the operation support system's modularized design provides system extensibility for newly added broadband access and other methodologies. The operation support system may include centralized processing and/or distributed processing. As described above, the operation support system of the present disclosure in one embodiment may include a plurality of subsystems or separate modules for performing specific tasks. In one embodiment, the connectivity between various function modules may use middleware and database proxy data agent. The operation support system is enabled to support a plurality of access methods including but not limited to narrowband dial in 102, VPDN 104, broadband 106, etc., and may use system external ports to connect with other systems.

The operation support system of the present disclosure in an exemplary embodiment is a multilayered application system. A plurality of applications may be built on top of an operating system and database and data warehouse platform. Middleware technology may be used between system platforms. Via DB-proxy such as data agents, application system and database and data warehouse communicate with other systems such as bank servers and other systems, for instance, through external ports.

In one embodiment, the operation support system of the present disclosure includes basic module component and expansible module component. In one embodiment, the basic module manages user, authentication and authorization, gathering and consolidating data, costing, and system administration. Basic module component also fulfills basic broadband WAN operation requirements. In one embodiment, expansible module comprises accounting, work order, self-service, card system, and statistics analysis module. Expansible module supports a plurality of value added services on broadband network. Statistics analysis model may help the operator to adjust operation strategy by providing real time operation status.

In one embodiment, OSS applications may be divided into different parts or tasks such as business, management, data gathering, line management, policy-making support, and service. Business part may include but is not limited to accepting customer account application, accepting service request, processing customer payment, and inquiring customer personal information and payment information. Management part may be responsible for system initialization, system personnel, organization and management, daily logging management, supervising business, building and maintaining information, defining and maintaining billing policy, defining and maintaining discount strategy, and billing process, and customer payment over due management. Data gathering part may include but is not limited to applying common middleware technology to collect and consolidate original chargeable data. After verifying and consolidating various types of original billing data, it may unify billing data and store in a database. Line management part may include but is not limited to clearing equipments and initiating new services. It may be responsible for recording available resources, maintaining prints and inquiries, and tracking equipment work order. Policy-making support part may include but is not limited to policy-making support subsystem. It may automatically generate regular customer business statistics reports, analyze and consolidate operation statistical data, for instance, and help business operator to understand the real time operation status and adjust operation strategy. Service part may include but is not limited to customer self-service system and customer support programs. It may allow a customer to inquire about customer personal information and account information through web and also manage customer feedbacks. One or more of the subsystems 1506, 1508, 1510, 1516, 1512, 1514 shown in FIG. 15 may perform one or more of these tasks.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc. The terms “computer system” and “computer network” as may be used in the present application may include but are not limited to a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. The term “module” as used in the present application may be a component of a device, software program or system that implements some “functionality” and may be embodied as software, hardware, firmware, electronic circuitry, etc. The embodiments described above are illustrative examples and it should not be construed that the present invention is limited to these particular embodiments.

Thus, various changes and modifications may be effected by one skilled in the art without departing from the spirit or scope of the invention as defined in the appended claims.

We claim:

1. A flexible operating system set top box, comprising:
an operating system operable to boot a set top box and prompt for and receive user selected media service operator, the operating system further operable to download a second operating system associated with the selected media service operator for providing media service to the user from the selected media service operator;
a memory for storing the second operating system associated with the selected media service operator; and
a runtime emulator operable to interpret and convert the second operating system associated with the selected media service operator to common machine code operable to run on a hardware platform of a set top box.

2. The set top box of claim 1, further including:
a preinstalled broadcast operating system.

3. The set top box of claim 1, wherein the user selected media service operator includes at least one of cable operator, satellite operator, and IPTV operator.

4. The set top box of claim 1, wherein the operating system further includes user interface for interacting with a user and a remote server.

5. The set top box of claim 4, wherein the user interface is a browser.

6. The set top box of claim 1, further including a parsing engine operable to parse data received at the set top box into a plurality of components for sending to one or more devices connected to the set top box.

7. The set top box of claim 6, wherein the one or more devices include at least a device for receiving media content and a device for receiving interactive advertisement.

8. The set top box of claim 7 configurable for receiving broadband media signals embodying a multimedia presentation from a content provider, said received signals further including supplemental information content relating to said multimedia presentation, said parsing engine parsing out said supplemental information content from said received broadband media signals and communicating them for viewing via a remote device.

9. The set top box of claim 8, further comprising:
a first communication sub-system for enabling wireless communication between said set top box and said remote device, said remote device receiving said parsed out supplemental information content communicated from said set top box, said remote controller having a display interface for viewing said supplemental information content,
wherein a user viewing experience comfort level is increased by enabling said supplemental information content to be viewed via said remote device display interface while said multimedia presentation is being viewed on a television device.

10. The set top box as claimed in claim 9, wherein said supplemental information comprises text and graphic information content relating to said multimedia presentation.

11. The set top box as claimed in claim 9, wherein said remote device display interface includes a browser device for viewing a web page, said supplemental content including advertisement content for display as part of a web page by said browser device on the remote device.

12. The set top box as claimed in claim 11, further comprising:
a second communication sub-system for enabling communication between said STB and the Internet,
said supplemental information additionally comprising hyperlinks associated with web-sites promoting e-commerce interactivity with a user, said user being enabled to navigate to one or more Internet web-sites upon selection of hyperlinks via said remote device browser and interact with said web-site via said first and second communication sub-systems,
wherein a user is enabled to conduct e-commerce or other Internet functions without disturbing the user's television viewing experience.

13. A method for using a common set top box to provide services from a plurality of media service operators, the plurality of media service operators each having a proprietary operating system, comprising:
prompting a user to select a service operator from a plurality of operators;
receiving a public key associated with a selected operator;
downloading a proprietary operating system associated with the selected operator using the public key; and
converting the proprietary operating system to a machine code executable by the common set top box.

14. A dual display apparatus comprising:
a flexible operating system set-top box (STB) configurable for receiving broadband media signals embodying a multimedia presentation from a content provider, said received signals further including viewable supplemental information content relating to said multimedia presentation, said flexible operating system STB associated with a playback device adapted for playing said multimedia presentation;
a parser, residing in said set top box, for parsing out said supplemental information content from said received broadband media signals;
an associated remote device adapted to communicate with said STB for controlling STB operations;
a first communication sub-system for enabling wireless communication between said STB and said remote device, said remote device receiving said parsed out supplemental information content communicated from said STB, and said associated remote device having a display interface for viewing said received supplemental information content,
wherein a user viewing experience comfort level is increased by enabling said supplemental information content to be viewed via said associated remote device display while said multimedia presentation is being viewed on said playback device.

15. The dual display apparatus as claimed in claim 14, wherein said supplemental information comprises text and graphic information content relating to said multimedia presentation.

16. The dual display apparatus as claimed in claim 15, wherein said associated remote device display interface includes a browser device for viewing a web page, said supplemental content including advertisement content for display as part of a web page by said browser device on the remote device.

17. The dual display apparatus as claimed in claim 16, further comprising:
a second communication sub-system for enabling communication between said STB and the Internet,
said supplemental information additionally comprising hyperlinks associated with web-sites promoting e-commerce interactivity with a user, said user being enabled to navigate to one or more Internet web-sites upon selection of hyperlinks via said associated remote controller browser device and interact with said web-site via said first and second communication sub-systems,
wherein a user is enabled to conduct e-commerce or other Internet functions without disturbing the user's viewing experience of said multimedia presentation.

18. The dual display apparatus as claimed in claim 15, wherein said playback device comprises a television, said multimedia presentation including one of: audio, visual, or audio/visual content.

19. The dual display apparatus as claimed in claim 14, wherein said received broadband media signals are provided from a content provider over a terrestrial communications link.

20. The dual display apparatus as claimed in claim 14, wherein said received broadband media signals are provided from a content provider over a cable network communications link.

21. The dual display apparatus as claimed in claim 14, wherein said received broadband media signals are provided from a content provider over the Internet via a TCP/IP communications link.

22. The dual mode display apparatus as claimed in claim 17, wherein said broadband media signals comprise a multiplexed data stream including metadata comprising information relating to different content comprising the multiplexed data stream, said parser parsing out said supplemental information content from said received broadband media signals based on said metadata.

23. The dual display apparatus as claimed in claim 22, wherein information included in said metadata comprises advertisement and hyperlink content.

24. The dual display apparatus as claimed in claim 22, wherein information included in said metadata comprises STB operating system code for enabling specific functionality of said STB.

25. The dual display apparatus as claimed in claim 14, wherein said broadband media signals are communicated to said STB via a streaming server.

26. The dual display apparatus as claimed in claim 14, wherein said flexible operating system STB includes communications interface for interfacing with a card swiper device, a user enabling e-commerce purchases via a user debit or credit card via said card swiper device.

27. A method for viewing content comprising:
configuring a flexible operating system of a set-top box (STB) to receive and process broadband media signals embodying a multimedia presentation from a content provider, said received signals further including viewable supplemental information content relating to said multimedia presentation, said flexible operating system STB associated with a playback device adapted for playing said multimedia presentation;
parsing out, via a parser residing in said set top box, said supplemental information content from said received broadband media signals;
providing an associated remote device adapted to wirelessly communicate with said STB via a first communication sub-system, said remote device receiving said parsed out supplemental information content communicated from said STB, said associated remote device having a display interface for viewing said received supplemental information content,
enabling said supplemental information content to be viewed via said associated remote device display while said multimedia presentation is being viewed on said playback device, thereby increasing a user viewing experience-comfort level.

28. The method for viewing content as claimed in claim 27, wherein said supplemental information comprises text and graphic information content relating to said multimedia presentation.

29. The method for viewing content as claimed in claim 28, wherein said associated remote device display interface includes a browser device for viewing a web page, said supplemental content including advertisement content for display as part of a web page by said browser device on the remote device.

30. The method for viewing content as claimed in claim 29, wherein said supplemental information additionally comprises hyperlinks associated with web-sites promoting e-commerce interactivity with a user, said user
navigating to one or more Internet web-sites upon selection of hyperlinks via said associated remote device browser and interact with said web-site via said first and second communication sub-systems; and,
conducting an e-commerce transaction or other Internet function without disturbing the user's viewing experience of said multimedia presentation.

31. A method of providing interactive shopping capabilities to a user while receiving media services from a media operator, comprising:
parsing data received from a media operator to separate the data into at least media program content and advertisement content;
sending the media program content to a device for presenting media program to a user;
sending the advertisement content to an interactive device;
presenting the advertisement content on the interactive device; and
allowing the user to select and purchase one or more products or services advertised in the advertisement content via the interactive device without interrupting the media program presented on the device for presenting media program to a user.

32. The method of claim 31, wherein the step of allowing the user to select and purchase one or more products or services includes:
linking the user to a seller of the selected one or more products to perform shopping.

33. The method of claim 31, wherein the step of allowing the user to select and purchase one or more products or services includes:
allowing the user to navigate via the interactive device to a shopping site providing the selected one or more products or services to perform shopping.

34. The method of claim 31, wherein the step of presenting the advertisement content includes displaying a web page on the interactive device, the web page including one or more hyperlinks to one or more other web pages providing additional information on purchasing the one or more products or services.

35. The method of claim 31, wherein one or more products or services in the advertisement content presented on the interactive device is referred to in the media program being presented to the user.

36. The method of claim 31, wherein the media operator includes a broadcast EPG provider and an advertisement content from a broadcasting network and an advertisement content from the EPG provider is simultaneously displayed on the interactive device together with electronic program guide.

37. The set top box of claim 1, wherein the memory includes at least flash memory.
